(19) United States
(12) Patent Application Publication
(10) Pub. No.: US 2026/0122077 A1
(43) Pub. Date: Apr. 30, 2026

(54) METHOD AND APPARATUS FOR INSTANT MESSAGING SERVICE

(71) Applicant: KAKAO CORP., Jeju-si (KR)

(72) Inventors: Eu Gene KIM, Seongnam-si (KR); Han Nah SON, Seongnam-si (KR); Eun Jung LEE, Seongnam-si (KR)

(21) Appl. No.: 19/004,110

(22) Filed: Dec. 27, 2024

(30) Foreign Application Priority Data
Jan. 15, 2024 (KR) 10-2024-0006020

(51) Int. Cl. H04L 9/40; G06Q 20/10; H04L 51/04

(52) U.S. Cl. CPC H04L 63/108; G06Q 20/102; H04L 51/04

(57) ABSTRACT

Provided is a server including one or more processors configured to receive a chatroom generation request including subscription fee information for a chatroom usage pass from an operator terminal corresponding to an operator account, generate a chatroom set to be available to a subscriber account that subscribes to the chatroom usage pass in response to the chatroom generation request, receive a request to access the chatroom from a user terminal corresponding to a user account, and grant an access right for the chatroom to the user account based on the chatroom usage pass subscribed by the user account.

### CROSS-REFERENCE TO RELATED APPLICATION

This application claims the benefit of Korean Patent Application No. 10-2024-0006020 filed on January 15, 2024, in the Korean Intellectual Property Office, the entire disclosure of which is incorporated herein by reference for all purposes.

### BACKGROUND

### Technical Field

One or more embodiments relate to a technology for an instant messaging service.

### Description of the Related Art

The advancement in mobile smart devices has increased the use of online platform services for interaction with other users over a network. The online platform services for interaction with other users may include, as representative examples, a social networking service (SNS) which is an online platform for generating and consolidating social relationships through communication among users, information sharing, and expansion of personal connections, and an instant messaging service (IMS) which is an online platform for real-time content communication between two or more users. With the increase in communication via mobile devices, the development of technology for online platform services providing not only one-to-one communication with other users but also various forms of communication are required.

### BRIEF SUMMARY

According to an aspect, there is provided a method performed by a server, the method including receiving a chatroom generation request including subscription fee information for a chatroom usage pass from an operator terminal corresponding to an operator account, generating a chatroom set to be available to a subscriber account that subscribes to the chatroom usage pass in response to the chatroom generation request, receiving a request to access the chatroom from a user terminal corresponding to a user account, and granting an access right for the chatroom to the user account based on the chatroom usage pass subscribed by the user account.

The granting of the access right may include, when the user account has not subscribed to the chatroom usage pass, transmitting a subscription request for the chatroom usage pass to the user terminal, and when payment of a subscription fee based on the subscription fee information is succeeded, providing the chatroom usage pass to the user account.

The granting of the access right may include setting a period of use indicating a validity period of the right to access granted to the user account based on time at which the payment of the subscription fee is succeeded, determining a recurring payment date for maintaining subscription to the chatroom usage pass based on a termination date of the set period of use, when the determined recurring payment date arrives, attempting recurring payment of the subscription fee for the chatroom usage pass, and when the recurring payment is succeeded, extending the period of use and changing the recurring payment date based on a termination date of the extended period of use.

The generating of the chatroom may include obtaining a chatroom operation form for an operation of the chatroom from the operator terminal, when the chatroom operation form is approved, requesting for payment information for revenue based on a subscription fee for the chatroom usage pass to the operator terminal, when the payment information is obtained from the operator terminal, registering the obtained payment information as payment information of revenue based on the subscription fee for the chatroom usage pass, and when a configuration of the chatroom is received from the operator terminal after the payment information is obtained, generating the chatroom applied with the received configuration.

The method may further include receiving a cancellation request for payment of a subscription fee for the chatroom usage pass form the user terminal, and determining whether the payment is able to be cancelled based on whether the user account has entered the chatroom.

The method may further include receiving an operation termination request for terminating an operation of the chatroom from the operator terminal, determining an operation termination date of the chatroom in response to the operation termination request, when the determined operation termination date arrives, removing the subscriber account from the chatroom, and when the determined operation termination date arrives, allowing the operator account to leave the chatroom.

The method may further include receiving a new subscription restriction request for restricting new subscription to the chatroom usage pass from the operator terminal, setting to restrict the new subscription to the chatroom usage pass in response to the new subscription restriction request, repeating recurring payment of a subscription fee and extension of a period of use of an existing subscriber account that has subscribed to the chatroom usage pass before the new subscription restriction request to maintain the access right of the existing subscriber account for the chatroom, and when the user account has not subscribed to the chatroom usage pass, transmitting a display command of a guide message indicating that the new subscription to the chatroom usage pass is restricted to the user terminal.

The method may further include restricting the operator account from leaving the chatroom, and allowing the user account to leave the chatroom.

The method may further include receiving an inquiry request for subscription information of the chatroom usage pass from the operator terminal, and transmitting a display command of a screen including the subscription information to the operator terminal in response to the inquiry request, and the subscription information of the chatroom usage pass may include information about at least one of one or more subscriber accounts that have subscribed to the chatroom usage pass, a payment history of a subscription fee for the chatroom usage pass, a payment history of revenue based on the subscription fee for the chatroom usage pass, or a subscription product corresponding to the chatroom usage pass.

The method may further include receiving an inquiry request of information about the chatroom usage pass subscribed by the user account from the user terminal, and transmitting a display command of a screen including at least one of a title of a chatroom corresponding to each chatroom usage pass subscribed by the user account, information about the operator account, information about a payment method, a recurring payment date, a subscription fee, or a period of use to the user terminal in response to the inquiry request.

The method may further include receiving a request for extracting and displaying a message sent by the operator account from at least one terminal of the operator terminal or the user terminal, extracting a message sent by the operator account through the chatroom in response to the received request, and transmitting a display command of a screen including the extracted message to the at least one terminal.

The method may further include transmitting a display command of a screen of the chatroom in which a visual effect is applied to a message sent by the operator account to at least one terminal of the operator terminal or the user terminal.

The method may further include determining an operating mode of the chatroom as one of a first mode of restricting a user account having a right to send a message through the chatroom as the operator account or a second mode of granting the right to send a message to a user account that has entered the chatroom in response to an operating mode determination request received from the operator terminal, instructing the user terminal to display a screen on which a function of sending a message through the chatroom is restricted while the operating mode of the chatroom is the first mode, and instructing the user terminal to display a screen on which the function of sending a message through the chatroom is allowed while the operating mode of the chatroom is the second mode.

The method may further include, when the user account has not subscribed to the chatroom usage pass, determining whether subscription to the chatroom usage pass is possible based on a comparison result between the number of subscriber accounts of the chatroom usage pass and the number of allowed participants for the chatroom, and when it is determined that the subscription to the chatroom usage pass is not possible, transmitting a display command of a guide message indicating that the subscription to the chatroom usage pass is restricted due to the number of allowed participants for the chatroom to the user terminal, and the granting of the access right may include, when it is determined that new subscription to the chatroom usage pass is possible, transmitting a subscription request for the chatroom usage pass to the user terminal.

The method may further include receiving an inquiry request for a profile of the subscriber account from at least one terminal of the operator terminal or the user terminal, and transmitting a display command of a screen further including subscription information of the subscriber account for the chatroom usage pass together with the profile of the subscriber account to the at least one terminal in response to the inquiry request for the profile.

The method may further include receiving a right deprivation request for depriving the access right of the user account for the chatroom from the operator terminal, removing the user account from the chatroom in response to the right deprivation request, and transmitting a display command of a guide message indicating that the user account is removed from the chatroom to the user terminal.

According to another aspect, there is provided a server including a processor configured to receive a chatroom generation request including subscription fee information for a chatroom usage pass from an operator terminal corresponding to an operator account, generate a chatroom set to be available to a subscriber account that subscribes to the chatroom usage pass in response to the chatroom generation request, receive a request to access the chatroom from a user terminal corresponding to a user account, and grant an access right for the chatroom to the user account based on the chatroom usage pass subscribed by the user account.

According to still another aspect, there is provided a method performed by a user terminal, the method including transmitting a request to access a chatroom set to be available to a subscriber account that subscribes to a chatroom usage pass to a server, and receiving an access right for the chatroom based on the chatroom usage pass subscribed by a user account corresponding to the user terminal, wherein the chatroom is generated in response to a chatroom generation request including subscription fee information for the chatroom usage pass from an operator terminal corresponding to an operator account.

According to still another aspect, there is provided a user terminal including a processor configured to transmit a request to access a chatroom set to be available to a subscriber account that subscribes to a chatroom usage pass to a server, and receive an access right for the chatroom based on the chatroom usage pass subscribed by a user account corresponding to the user terminal, wherein the chatroom is generated in response to a chatroom generation request including subscription fee information for the chatroom usage pass from an operator terminal corresponding to an operator account.

Additional aspects of embodiments will be set forth in part in the description which follows and, in part, will be apparent from the description, or may be learned by practice of the disclosure.

### BRIEF DESCRIPTION OF THE SEVERAL VIEWS OF THE DRAWINGS

These and/or other aspects, features, and advantages of the disclosure will become apparent and more readily appreciated from the following description of embodiments, taken in conjunction with the accompanying drawings of which:

FIG. 1 is a diagram illustrating an example of a chatroom usage pass subscription system according to various embodiments;

FIG. 2 is a flowchart illustrating an example of a method of providing a chatroom usage pass subscription service performed by a server according to various embodiments;

FIG. 3 is a diagram illustrating an example of an operation of generating a chatroom by an operator terminal and a server according to various embodiments;

FIG. 4 is a diagram illustrating an example of screens for obtaining a chatroom operation form according to various embodiments;

FIG. 5A is a diagram illustrating an example of screens for registering payment information when a chatroom usage pass subscription system approves a chatroom operation form according to various embodiments;

FIG. 5B is a diagram illustrating an example of a screen including a guide message when a chatroom usage pass subscription system rejects a chatroom operation form according to various embodiments;

FIG. 6 is a diagram illustrating an example of an operation of a chatroom usage pass subscription system obtaining a configuration of a chatroom when payment information is registered according to various embodiments;

FIGS. 7A and 7B are diagrams illustrating an example of an operation of an operator terminal inquiring about subscription information of a chatroom according to various embodiments;

FIG. 8 is a diagram illustrating an example of an operation of a chatroom usage pass subscription system subscribing a chatroom usage pass according to various embodiments;

FIG. 9 is a diagram illustrating an example of an operation of a user terminal displaying an area for entering a cover screen of a chatroom according to various embodiments;

FIG. 10 is a diagram illustrating an example of an operation of a user terminal performing a payment process of a subscription fee for a chatroom usage pass according to various embodiments;

FIG. 11 is a diagram illustrating an example of an operation of a user terminal inquiring about information about a chatroom usage pass subscribed by a user account according to various embodiments;

FIG. 12 is a diagram illustrating an example of an operation of a chatroom usage pass subscription system terminating selling a chatroom usage pass according to various embodiments;

FIG. 13 is a diagram illustrating an example of an operation of a chatroom usage pass subscription system restricting new subscription to a chatroom usage pass according to various embodiments;

FIG. 14 is a diagram illustrating an example of an operation of a chatroom usage pass subscription system sending feedback of a subscriber to an operator according to various embodiments;

FIGS. 15A and 15B are diagrams illustrating an example of an operation of a chatroom usage pass subscription system providing a screen of a normal chatroom or a non-subscription type anonymous chatroom and a screen of a subscription type chatroom according to various embodiments;

FIG. 16 is a diagram illustrating an example of an operation of a chatroom usage pass subscription system providing a function of extracting a message of an operator according to various embodiments;

FIG. 17 is a diagram illustrating an example of an operation of a subscriber terminal cancelling subscription to a chatroom usage pass according to various embodiments;

FIG. 18 is a diagram illustrating an example of an operation of a chatroom usage pass subscription system providing a function of applying a visual effect to a message sent by an operator account according to various embodiments;

FIG. 19 is a diagram illustrating an example of an operation of a chatroom usage pass subscription system determining an account capable of sending a message through a subscription type chatroom according to various embodiments; and

FIG. 20 is a diagram illustrating an example of an operation of a chatroom usage pass subscription system providing a profile according to various embodiments.

### DETAILED DESCRIPTION

The following detailed structural or functional description is provided as an embodiment only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that when it is described that one component is “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like elements and a repeated description related thereto will be omitted.

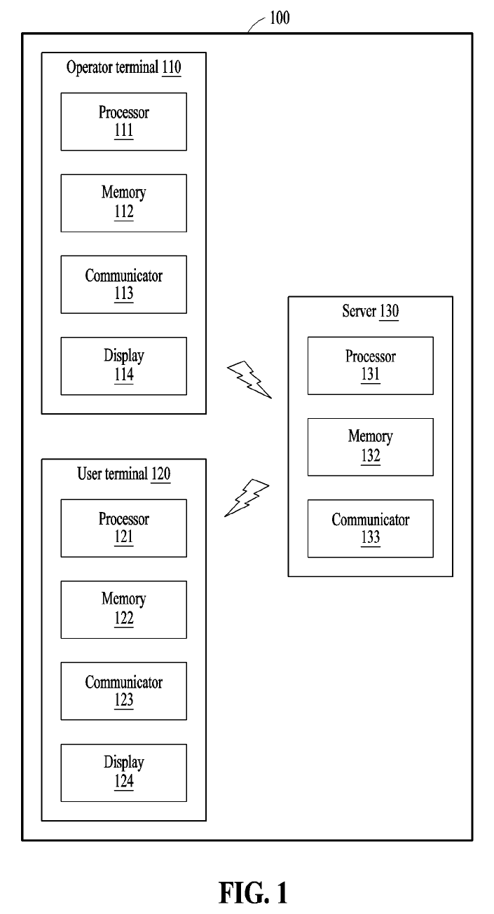

FIG. 1 is a diagram illustrating an example of a chatroom usage pass subscription system according to various embodiments.

A chatroom usage pass subscription system 100 according to an embodiment may include an operator terminal 110, a user terminal 120, and a server 130.

The operator terminal 110 may be one of electronic apparatuses including a computer, a portable computer, a wireless phone, a mobile phone, a smartphone, a personal digital assistant (PDA), a web tablet, and the like. The operator terminal 110 may refer to any apparatus that may install and execute a service application related to the server 130. Here, the operator terminal 110 may perform overall service operations such as service screen configuration, data input, data transmission and reception, and data storage under the control of the application. For example, the operator terminal 110 may access the server 130 through the application. For example, the operator terminal 110 may use an instant messaging service (IMS) provided by the server 130.

Similarly to the operator terminal 110, the user terminal 120 may be one of electronic apparatuses including a computer, a portable computer, a wireless phone, a mobile phone, a smartphone, a PDA, a web tablet, and the like. The user terminal 120 may refer to any apparatus that may install and execute a service application related to the server 130. Here, the user terminal 120 may perform overall service operations such as service screen configuration, data input, data transmission and reception, and data storage under the control of the application. For example, the user terminal 120 may access the server 130 through the application. For example, the user terminal 120 may use an IMS provided by the server 130.

The server 130 may provide a service to the operator terminal 110 and/or the user terminal 120. For example, the server 130 may provide an IMS or a social networking service (SNS). The server 130 may provide a chatroom usage pass subscription service. According to an embodiment, the server 130 may include an instant messaging server (not shown) and a subscription server (not shown). The instant messaging server may provide an IMS to the operator terminal 110 and/or the user terminal 120. The subscription server may provide a subscription service (e.g., a chatroom usage pass subscription service) to the operator terminal 110 and/or the user terminal 120. The chatroom usage pass subscription service may provide generation of a chatroom, sale of a subscription product corresponding to a chatroom usage pass, and/or an operation of a chatroom to the operator terminal 110, and provide subscription to a chatroom usage pass and/or use of a chatroom to the user terminal 120.

According to an embodiment, the server 130 may provide a service (e.g., the chatroom usage pass subscription service) for providing a chatroom usage pass for a chatroom generated and/or operated by a specific user (e.g., an operator) to another user (e.g., a subscriber) as a subscription product. As will be described below in more detail, the server 130 may sell an access right for a chatroom generated based on a request of a specific user to another user as a subscription product which is a chatroom usage pass, thereby providing revenue based on a subscription fee to the specific user (e.g., an operator) and providing a content of the operator to the other user (e.g., a subscriber) through a chatroom.

In various embodiments, the operator terminal 110 and the user terminal 120 are described separately, but the operator terminal 110 and the user terminal 120 are each example of devices that use a service provided by the server 130. A device of a user that generates and/or operates a specific chatroom may be expressed as the operator terminal 110 based on the specific chatroom, and a device of a user other than the operator of the chatroom may be expressed as the user terminal 120 based on the specific chatroom. A terminal (e.g., the user terminal 120) of a subscriber that subscribes a chatroom usage pass may also be expressed as a subscriber terminal based on the specific chatroom. According to an embodiment, a specific user (or a user account) may be an operator of a first chatroom while being a subscriber of a second chatroom. A terminal of the specific user may be the operator terminal 110 based on the first chatroom while being the user terminal 120 (or a subscriber terminal) based on the second chatroom.

An account of the user (e.g., an operator account or a user account) may be generated when a user joins a service provided by the server 130, and the server 130 may function as a service platform that provides a service to the user account that has joined a service such as an SNS, an IMS, or the like. In various embodiments, the user account will be described mainly as an account that has joined an IMS. Since a terminal (e.g., the operator terminal 110 or the user terminal 120) of the user uses a service using an account (e.g., an operator account or a user account) of the user, it may be understood that the account of the user included in the following embodiments corresponds to the terminal of the user.

According to an embodiment, the operator terminal 110 may include a processor 111, a memory 112, a communicator 113, and a display 114.

The processor 111 may transmit a chatroom generation request including subscription fee information for a chatroom to the server 130. The processor 111 may receive a display command of a screen and/or a guide message for a chatroom from the server 130. The processor 111 may display the screen and/or the guide messages for the chatroom. The processor 111 may store data required for transmission of a chatroom generation request, reception of a display command, and/or display of a screen or a guide message in a memory temporarily or permanently.

The memory 112 may store information about the chatroom generation request, the screen and/or the guide message for the chatroom. The memory 112 may store instructions for the transmission of the chatroom generation request, the reception of the display command, and/or the display of the screen or the guide message.

The communicator 113 may transmit at least one of the chatroom generation request or the display command. The communicator 113 may establish a wired communication channel and/or a wireless communication channel with an external apparatus (e.g., the user terminal 120, another electronic device, or and the server 130), and for example, establish communication through cellular communication, short-range wireless communication, local area network (LAN) communication, Bluetooth, wireless fidelity (Wi-Fi) direct or infrared data association (IrDA), or a long-range communication network such as a legacy cellular network, a fourth generation (4G) and/or fifth generation (5G) network, next generation communication, the Internet, or a computer network (e.g., a LAN or a wide area network (WAN)).

The display 114 may visualize the screen and/or the guide message for the chatroom. For example, the display 114 may be, for example, a touch display in which a touch sensing module and a display module are integrally implemented.

According to an embodiment, the user terminal 120 may include a processor 121, a memory 122, a communicator 123, and a display 124.

The processor 121 may transmit a request to use a chatroom to the server 130. The processor 121 may receive a subscription request for subscribing to a chatroom from the server 130. The processor 121 may display a screen to pay a subscription fee. The processor 121 may store data required for the transmission of the request to use a chatroom, the reception of the subscription request, and/or the display of the screen to pay the subscription fee in a memory temporarily or permanently.

The memory 122 may store information about the request to use a chatroom, the subscription request, and/or the screen to pay the subscription fee. The memory 122 may store instructions for the transmission of the request to use a chatroom, the reception of the subscription request, and/or the display of the screen to pay the subscription fee.

The communicator 123 may transmit at least one of the requests to use a chatroom, the subscription request, and/or a display command of the screen to pay the subscription fee. The communicator 123 may establish a wired communication channel and/or a wireless communication channel with an external apparatus (e.g., the operator terminal 110, another electronic device, or and the server 130), and for example, establish communication through cellular communication, short-range wireless communication, LAN communication, Bluetooth, wi-Fi direct or IrDA, or a long-range communication network such as a legacy cellular network, a 4G and/or 5G network, next generation communication, the Internet, or a computer network (e.g., a LAN or a WAN).

The display 124 may visualize the request to use a chatroom, the subscription request, and/or the screen to pay the subscription fee. For example, the display 124 may be, for example, a touch display in which a touch sensing module and a display module are integrally implemented.

According to an embodiment, the server 130 may include a processor 131, a memory 132, and a communicator 133.

The processor 131 may receive the chatroom generation request including the subscription fee information from the operator terminal 110. The processor 131 may generate a chatroom in response to the chatroom generation request. The processor 131 may receive the request to use a chatroom from the user terminal 120. When a user account of the user terminal 120 has not subscribed a chatroom usage pass, the processor 131 may transmit the subscription request to the user terminal 120. When payment of the subscription fee to subscribe to the chatroom usage pass is succeeded, the processor 131 may grant an access right for the chatroom to the user account. The processor 131 may store data required for reception of the chatroom generation request, generation of the chatroom, reception of the request to use, transmission of the subscription request, and/or granting the access right in a memory temporarily or permanently.

The memory 132 may store information about the chatroom generation request, the chatroom, the request to use, the subscription request, and/or the access right. The memory 132 may store instructions for the reception of the chatroom generation request, the generation of the chatroom, the reception of the request to use, the transmission of the subscription request, and/or the granting of the access right.

The communicator 133 may transmit at least one of information about the chatroom generation request, the chatroom, the request to use, the subscription request, or the access right. The communicator 133 may establish a wired communication channel and/or a wireless communication channel with an external apparatus (e.g., the operator terminal 110, the user terminal 120, or another electronic device), and for example, establish communication through cellular communication, short-range wireless communication, LAN communication, Bluetooth, wi-Fi direct or IrDA, or a long-range communication network such as a legacy cellular network, a 4G and/or 5G network, next generation communication, the Internet, or a computer network (e.g., a LAN or a WAN).

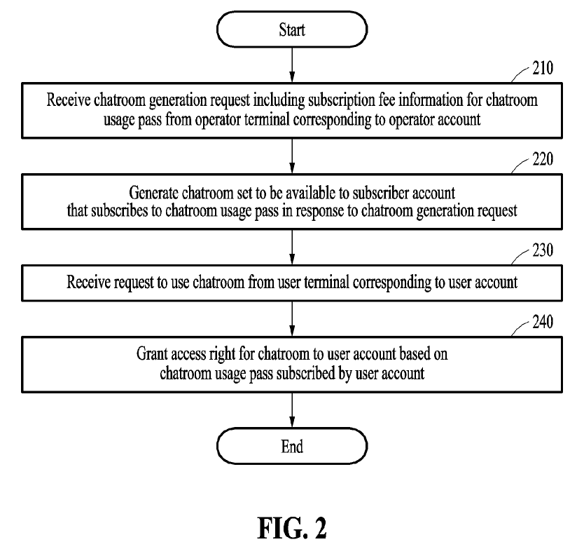

FIG. 2 is a flowchart illustrating an example of a method of providing a chatroom usage pass subscription service performed by a server according to various embodiments.

A server according to an embodiment (e.g., the server 130 of FIG. 1) may provide a chatroom usage pass subscription service to an operator terminal (e.g., the operator terminal 110 of FIG. 1) and a user terminal (e.g., the user terminal 120 of FIG. 1).

In operation 210, the server may receive a chatroom generation request including subscription fee information for a chatroom usage pass from the operator terminal corresponding to an operator account.

For example, the operator terminal may refer to a terminal that has accessed a service provided by the server using the operator account. The operator terminal may refer to a terminal of an operator that generates and/or operates a chatroom using the operator account. The operator terminal may request the server to generate a chatroom and a subscription product for a chatroom usage pass of the chatroom. In various embodiments of the present disclosure, in a case of selling a subscription product corresponding to a chatroom usage pass indicating the right to access a chatroom, the chatroom may also be expressed as a subscription type chatroom. The subscription product corresponding to the chatroom usage pass may refer to a product that provides a chatroom usage pass to a user account during a period of use according to succeeded payment of a subscription fee, and grants the access right for a chatroom to a user account (e.g., a subscriber account) having the chatroom usage pass. In various embodiments of the present disclosure, the subscription may include recurring subscription, and the period of use may extend by recurring payment of the subscription fee (e.g., on predetermined schedule).

In various embodiments of the present disclosure, the subscription type chatroom may refer to a type of anonymous chatroom. The anonymous chatroom service may include a service of Open Chat (registered trademark of Kakao Corporation) provided by the Applicant, Kakao Corporation, specifically, a nonacquaintance-based open chat service provided by the Applicant, Kakao Corporation, and the anonymous chatroom may refer to a chatroom of the open chat service provided by the Applicant, Kakao Corporation. The open chat service provided by Kakao Corporation is merely an example of an anonymous chatroom service, and is not limited thereto. The anonymous chatroom service may include services that provide chatrooms in which participants participate through temporary profiles rather than real-name accounts. In various embodiments of the present disclosure, the chatroom usage pass subscription service, which provides chatroom access to an anonymous chatroom as a subscription product, may also be expressed as Open Chat Plus (or Open Chat Plus Service).

The chatroom generation request may include information about a chatroom or a chatroom usage pass. For example, the information about the chatroom may include at least one of a title of the chatroom, description of the chatroom, a condition for entering the chatroom (e.g., gender, academic background, identity, certificate, or organization), a category of the chatroom (e.g., economy, hobby, language, amity, information sharing, self-development, or counselling), a keyword for the chatroom (e.g., tags), or an expected operating period of the chatroom. The information about the chatroom usage pass may include at least one of subscription fee information, price of the chatroom usage pass, cycle of recurring payment of the chatroom usage pass, or whether to provide a free trial of the chatroom usage pass.

The subscription fee information may refer to information indicating the subscription fee paid for each regular payment of the chatroom usage pass. The subscription fee information may include a subscription fee and a length of the period of use of the chatroom usage pass extending according to the succeeded payment of the subscription fee. The period of use may indicate the validity period of the chatroom usage pass. For example, the subscription fee information may include a subscription fee for providing a chatroom usage pass to a user account for a predetermined period of time (e.g., 1 month). According to an embodiment, the subscription fee information may further include a first subscription fee (e.g., 10,000 won) for a first length (e.g., 1 month) of the period of use, and a second subscription fee (e.g., 100000 won) for a second length (e.g., 12 months) of the period of use, and the server may provide one of the payment of the first subscription fee or the payment of the second subscription fee as an option to a user who wishes to subscribe to the chatroom usage pass. The user account may obtain a chatroom usage pass that is valid for the first length of the period of use when the payment of the first subscription fee is paid, and may obtain a chatroom usage pass that is valid for the second length of the period of use when the payment of the second subscription fee is paid.

The chatroom usage pass may refer to an access right for the chatroom. As will be described below, the server may grant an access right for a chatroom during a validity period of a chatroom usage pass to a user account that has purchased the chatroom usage pass.

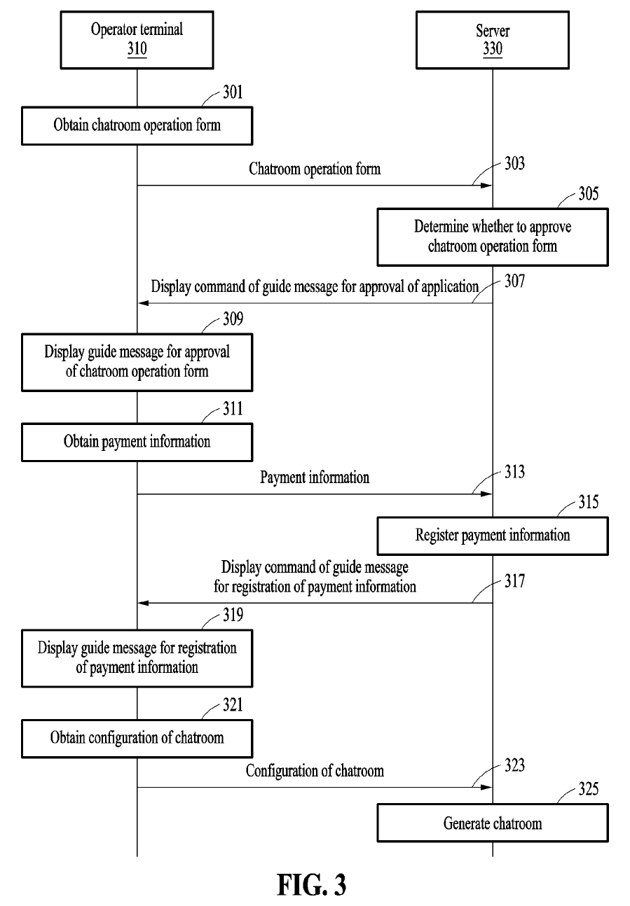

In operation 220, the server may generate a chatroom set to be available to a subscriber account that subscribes to the chatroom usage pass in response to the chatroom generation request. The server may register a subscription product corresponding to the chatroom usage pass along with the chatroom. The server may generate an address (e.g., a uniform resource locator (URL) address or a quick response (QR) code) that links to a chatroom or a cover screen of a chatroom. The generation of the chatroom and/or the cover screen of the chatroom will be described below in more detail with reference to FIGS. 3 to 6.

In operation 230, the server may receive a request to use the chatroom from a user terminal corresponding to the user account.

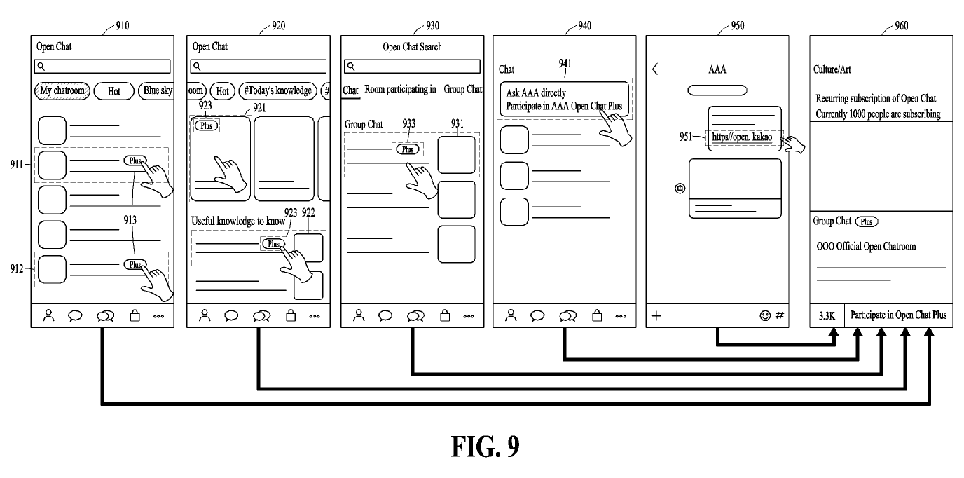

The server may cause the user terminal to display an area for entering the chatroom based on the generation of the chatroom or the registration of the subscription product corresponding to the chatroom usage pass. The operation of displaying, by the user terminal, the area for entering the chatroom will be described below in more detail with reference to FIG. 9.

The user terminal may receive a display command of a screen from the server while using the service provided by the server. The user terminal may display a screen including an area corresponding to the chatroom (e.g., a subscription type chatroom). The user terminal may detect a user input for entering the chatroom through the screen. The user terminal may transmit the request to access the chatroom to the server based on the user input. The request to access the chatroom may include a request for a user account to enter the chatroom.

In various embodiments of the present disclosure, the user account entering the chatroom may imply that the user account that is not a participant in the chatroom is registered as a participant in the chatroom. The user account participating in the chatroom may imply that the user account is in a state of being registered as a participant in the chatroom. In other words, when the user account enters a chatroom, the state of the user account may change from a state not participating in the chatroom to a state participating in the chatroom. While the user account is registered as a participant in the chatroom, the user terminal corresponding to the user account may receive and/or view messages sent through the chatroom. The user account leaving the chatroom may imply that the user account registered as a participant in the chatroom is excluded from the participant in the chatroom. While the user account is not a participant in the chatroom (e.g., while being excluded from the participant of the chatroom), the user terminal corresponding to the user account may not be able to receive and/or view messages sent through the chatroom. In other words, when the user account has left the chatroom, the state of the user account may change from a state of participating in the chatroom to a state of not participating in the chatroom.

In operation 240, the server may grant the access right for the chatroom to the user account based on the chatroom usage pass subscribed by the user account. The user terminal may receive the access right for the chatroom based on the chatroom usage pass subscribed by the user account.

When the user account has not subscribed to the chatroom usage pass, the server may transmit the subscription request for the chatroom usage pass to the user terminal.

The server may access the information about the chatroom usage pass subscribed by each of a plurality of user accounts. When the request to access the subscription type chatroom is received from the user terminal, the server may confirm whether the user account corresponding to the user terminal subscribes to the chatroom usage pass of the chatroom. When the user account has not subscribed to the chatroom usage pass, the server may transmit the subscription request for the chatroom usage pass to the user terminal.

For example, the server may transmit a display command of a screen for the payment of the subscription fee for the chatroom usage pass to the user terminal. The subscription fee for the chatroom usage pass may be the amount of money determined based on the subscription fee information included in the chatroom generation request. The user terminal may display the screen for the payment of the subscription fee in response to the display command received from the server.

The user terminal may request the payment of the subscription fee by transmitting payment information (e.g., credit card information) to a server (e.g., a payment server). The server may attempt to pay the subscription fee based on the payment information and then transmit a payment approval result to the user terminal and/or the operator terminal.

When the payment of the subscription fee based on the subscription fee information is succeeded, the server may grant the access right for the chatroom to the user account.

When the payment of the subscription fee is succeeded, the server may store information about the subscription to the chatroom usage pass by the user terminal. In other words, when the payment of the subscription fee by the user account is succeeded, the user account may be switched to a subscriber account that subscribes to the chatroom usage pass.

The access right for the chatroom may include at least one of participating in the chatroom as the user account enters the chatroom, viewing messages sent and received between other user accounts participating in the chatroom through the chatroom, sending a message to another user account participating in the chatroom through the chatroom, viewing a post uploaded to a board corresponding to the chatroom, or uploading a post to the board corresponding to the chatroom.

According to an embodiment, the server may perform a process for a user account attempting to leave the chatroom differently depending on whether the user account is the operator account of the chatroom or the subscriber account of the chatroom. For example, the server may restrict the operator account of the chatroom from leaving the chatroom. The server may allow the user account that subscribes to the chatroom usage pass to leave the chatroom.

In the chatroom usage pass subscription system according to an embodiment, the operator account of the chatroom may receive revenue for operating the chatroom based on the subscription fee paid by the user account (e.g., the subscriber account). Thus, the server may restrict the operator account of the chatroom from leaving the subscription type chatroom in terms of forcing the operator account to continue operating the chatroom. On the other hand, the server may not specifically restrict the subscriber account of the subscription type chatroom from leaving the subscription type chatroom (e.g., may allow to leave).

However, the server according to an embodiment may process the entering and leaving of the chatroom independently of the subscription of the chatroom usage pass. For example, even in a case where the user account has left the chatroom, the server may allow the user account to enter the chatroom when the user account requests to enter the chatroom within the period of use of the chatroom usage pass. In a case where the user account has left the chatroom, if the recurring payment of the chatroom usage pass is not cancelled, the server may perform the recurring payment for the subscription fee for the chatroom usage pass, and extend the period of use of the chatroom usage pass according to the success of the payment of the subscription fee.

According to an embodiment, when the user account leaves the chatroom, the server may transmit a display command of a guide message showing that the subscription to the chatroom usage pass is not cancelled and a screen for entering a subscription cancellation process to the user terminal. When the user wishes to cancel the subscription to the chatroom usage pass, the user may transmit a subscription cancellation request of the chatroom usage pass to the server using the guide message and the screen displayed by the user terminal, and cancel the subscription to the chatroom usage pass, as the subscription cancellation process is performed by the server.

In the chatroom usage pass subscription system according to an embodiment, the operator may remove a specific subscriber from the chatroom. The specific subscriber may be an abusing subscriber including subscribers who does not follow operating rules of a chatroom or engage in behavior that is detrimental to other subscribers. The operator terminal may transmit a right deprivation request for depriving the access right of the user account (e.g., the subscriber account) that has subscribed to the chatroom usage pass for the chatroom to the server. The server may receive the right deprivation request for depriving the access right of the user account for the chatroom from the operator terminal. The server may remove the user account from the chatroom in response to the right deprivation request. The server may transmit a display command of a guide message indicating that the user account is removed from the chatroom to the user terminal. The user terminal may display the guide message indicating that the user account is removed from the chatroom.

According to an embodiment, in the chatroom usage pass subscription system, the cancellation of the subscription to the chatroom usage pass of the subscriber who is removed from the chatroom by the operator is not performed automatically, and the subscription to the chatroom usage pass may be cancelled based on a separate request from the subscriber who is removed. The server may transmit a display command of the guide message regarding the cancellation of the subscription to the chatroom usage pass together with the guide message indicating that the user account is removed from the chatroom to the user terminal. The user terminal may display the guide message regarding the cancellation of the subscription to the chatroom usage pass. A user may generate the subscription cancellation request based on the guide message regarding the cancellation of the subscription displayed by the user terminal. The user terminal may transmit the subscription cancellation request to the server, and the server may cancel the subscription to the chatroom usage pass of the user account in response to the subscription cancellation request.

According to an embodiment, in the chatroom usage pass subscription system, the number of allowed participants who may participate in the chatroom may be set. The server may determine whether the user account is able to subscribe to the chatroom based on a comparison result between the number of allowed participants and the number of subscriber accounts of the chatroom usage pass.

For example, the server may set the number of allowed participants for the chatroom. The server may set the number of allowed participants for the chatroom based on information (e.g., the chatroom generation request, the chatroom operation form, settings of the chatroom, or a request to change the settings of the chatroom) received from the operator terminal. The number of allowed participants for the chatroom may refer to a limited number of user accounts participating in the chatroom.

In the chatroom usage pass subscription system according to an embodiment, when the chatroom is a subscription type chatroom, the number of allowed participants for the chatroom may be compared with the number of subscriber accounts of the chatroom usage pass rather than the number of user accounts entering and participating in the chatroom, in order to secure the access right (e.g., a right to participate or a right to enter) of the user accounts that have subscribed to the chatroom usage pass (e.g., paid the subscription fee) for the chatroom. For example, the server may receive the request to use the chatroom from the user terminal. When the user account has not subscribed to the chatroom usage pass, the server may determine whether the user account is able to subscribe to the chatroom usage pass based on a comparison result between the number of subscriber accounts of the chatroom usage pass and the number of allowed participants for the chatroom. When the number of subscriber accounts of the chatroom usage pass is greater than or equal to the number of allowed participants, the server may determine that the user account is not able to subscribe to the chatroom usage pass. When the number of subscriber accounts of the chatroom usage pass is less than the number of allowed participants, the server may determine that the user account is able to subscribe to the chatroom usage pass.

When it is determined that the subscription to the chatroom usage pass is not possible, the server may transmit a display command of a guide message indicating that the subscription to the chatroom usage pass is restricted due to the number of allowed participants for the chatroom to the user terminal. The user terminal may display the guide message indicating that the subscription to the chatroom usage pass is restricted due to the number of allowed participants. When it is determined that the new subscription to the chatroom usage pass is possible, the server may transmit a subscription request for the chatroom usage pass to the user terminal.

FIG. 3 is a diagram illustrating an example of an operation of generating a chatroom by an operator terminal and a server according to various embodiments.

A chatroom usage pass subscription system (e.g., the chatroom usage pass subscription system 100 of FIG. 1) according to an embodiment may include an operator terminal 310 (e.g., the operator terminal 110 of FIG. 1) and a server 330 (e.g., the server 130 of FIG. 1). The operator terminal 310 may transmit a chatroom generation request to the server 330, and the server 330 may generate a chatroom in response to the chatroom generation request. The chatroom generation request according to an embodiment may include at least one of a chatroom operation form, payment information, or a configuration of a chatroom.

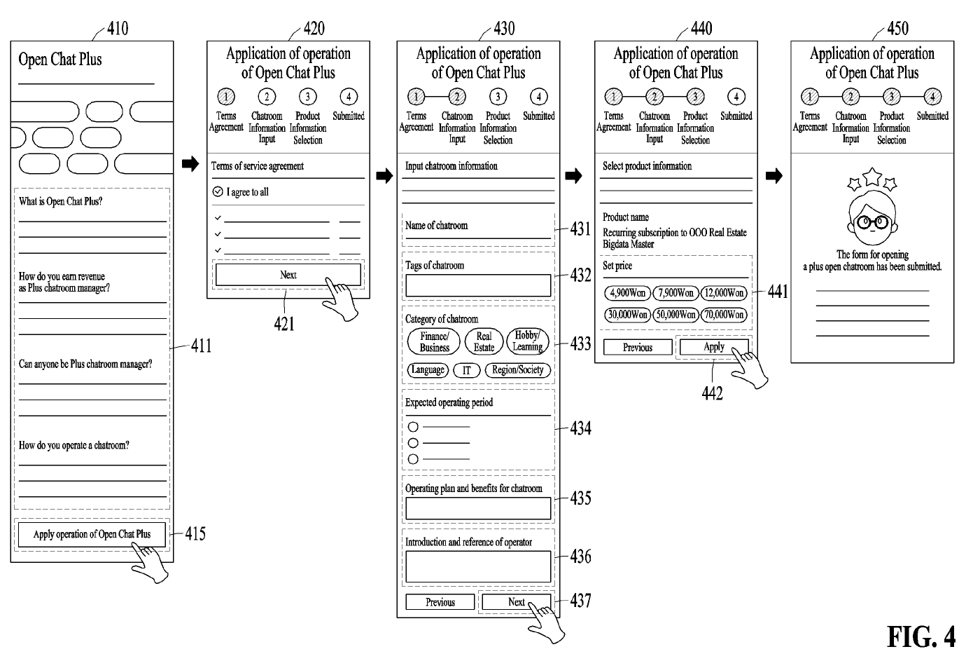

In operation 301, the operator terminal 310 may obtain the chatroom operation form for the operation of a chatroom. The chatroom operation form may include information required to determine whether to approve the chatroom operation form in a chatroom usage pass subscription system among information about a chatroom and/or information about a chatroom usage pass. The chatroom operation form may include information requesting the approval for a subscription type chatroom. The chatroom operation form may include the information about a chatroom and/or the information about a chatroom usage pass. An example of the operation of obtaining the operation application by the operator terminal 310 will be described below in more detail with reference to FIG. 4.

In operation 303, the operator terminal 310 may transmit the chatroom operation form to the server 330. The server 330 may obtain (e.g., receive) the chatroom operation form from the operator terminal 310.

In operation 305, the server 330 may determine whether to approve the chatroom operation form based on the chatroom operation form. For example, the server 330 may provide the information about a chatroom and/or the information about a chatroom usage pass included in the chatroom operation form to a manager of a chatroom usage pass subscription service, and determine whether to approve the chatroom operation form (or generation of a chatroom) according to an input of the manager. In FIG. 3, for example, the server 330 may approve the chatroom operation form.

In operation 307, the server 330 may transmit a display command of a guide message for the approval of the chatroom operation form to the operator terminal 310. The operator terminal 310 may receive the display command of the guide message for the approval of the chatroom operation form from the server 330.

In operation 309, the operator terminal 310 may display the guide message for the approval of the chatroom operation form.

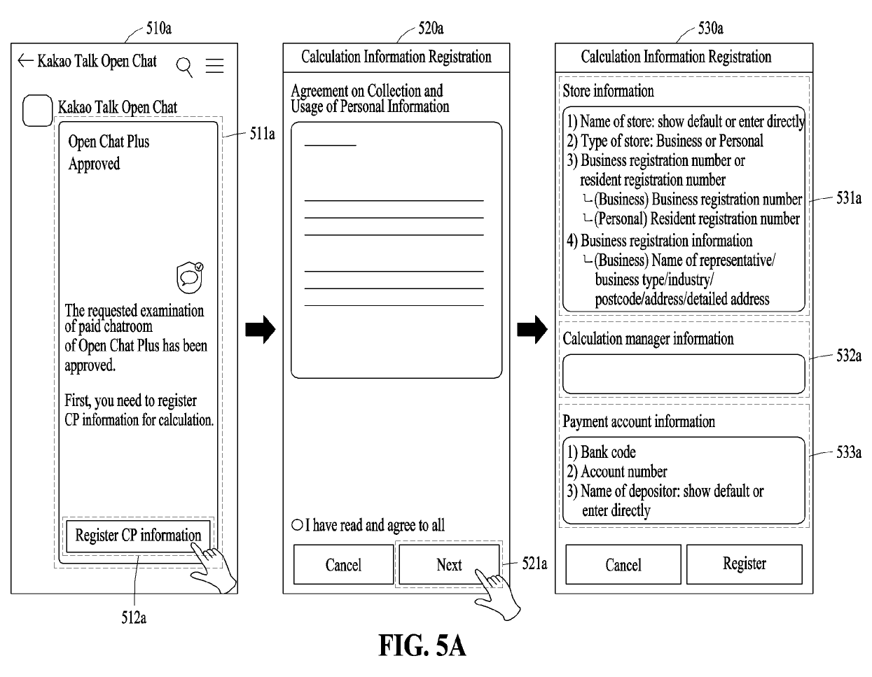

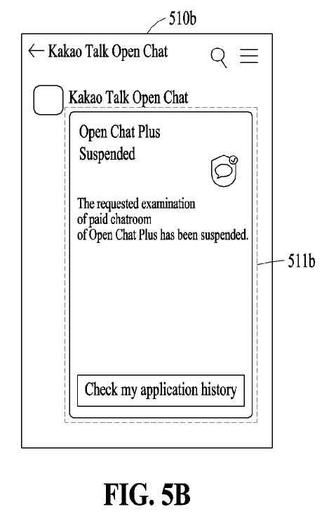

Although not explicitly shown in FIG. 3, when it is determined that the chatroom operation form is not approved (e.g., rejected) by the server 330, the server 330 may transmit a display command of a guide message for rejection of the chatroom operation form to the operator terminal 310, and the operator terminal 310 may display the guide message for the rejection of the chatroom operation form. An example of the guide message for the approval or rejection of the chatroom operation form will be described below in more detail with reference to FIGS. 5A and 5B.

In operation 311, the operator terminal 310 may obtain payment information. The payment information may refer to payment information (e.g., an account number or a business registration number) for revenue based on a subscription fee for the chatroom usage pass. In various embodiments of the present disclosure, the payment information may also be expressed as calculation information or content provider (CP) information. When the chatroom operation form is approved, the server 330 may request the payment information to the operator terminal 310. For example, the server 330 may transmit a display command of a screen for inputting the payment information to the operator terminal 310. The operator terminal 310 may display the screen for inputting the payment information based on the approval of the chatroom operation form. The operator terminal 310 may obtain the payment information based on an input of an operator. An example of the screen for inputting the payment information will be described below in more detail with reference to FIG. 5A.

In operation 313, the operator terminal 310 may transmit the payment information to the server 330. The server 330 may obtain the payment information from the operator terminal 310.

In operation 315, when the payment information is obtained from the operator terminal 310, the server 330 may register the obtained payment information as payment information of revenue based on the subscription fee for the chatroom usage pass.

In operation 317, the server 330 may transmit a display command of a guide message for registration of the payment information. The operator terminal 310 may receive the display command of the guide message for the registration of the payment information.

In operation 319, the operator terminal 310 may display the guide message for the registration of the payment information.

In operation 321, the operator terminal 310 may obtain a configuration of the chatroom.

The configuration of the chatroom may include a detailed configuration (or final configuration) for a chatroom to be generated. For example, the configuration of the chatroom may refer to a configuration of the chatroom independent of the chatroom operation form, among items not included in the chatroom operation form. For example, the configuration of the chatroom may include a profile of an operator account to be used in a chatroom, whether to request participants of a chatroom to participate a chatroom with a specific profile (e.g., a default profile or an anonymous profile), whether to allow search in a chatroom, or information about conditions for entering a chatroom.

For example, the configuration of the chatroom may include items that are at least partially the same as items of the information about the chatroom included in the chatroom operation form. When the information about the chatroom is partially changed, the configuration of the chatroom may include changes in the information about the chatroom included in the chatroom operation form. For example, a title of the chatroom may be changed after the chatroom operation form input, and may become different from a title of the chatroom included in the chatroom operation form. The configuration of the chatroom may include the changed title of the chatroom.

When the payment information is registered, the server 330 may request for the configuration of the chatroom to the operator terminal 310. For example, the server 330 may transmit a display command of a screen for inputting the configuration of the chatroom to the operator terminal 310. The operator terminal 310 may display the screen for inputting the configuration of the chatroom based on the registration of the payment information. The operator terminal 310 may obtain the configuration of the chatroom based on the input of the operator.

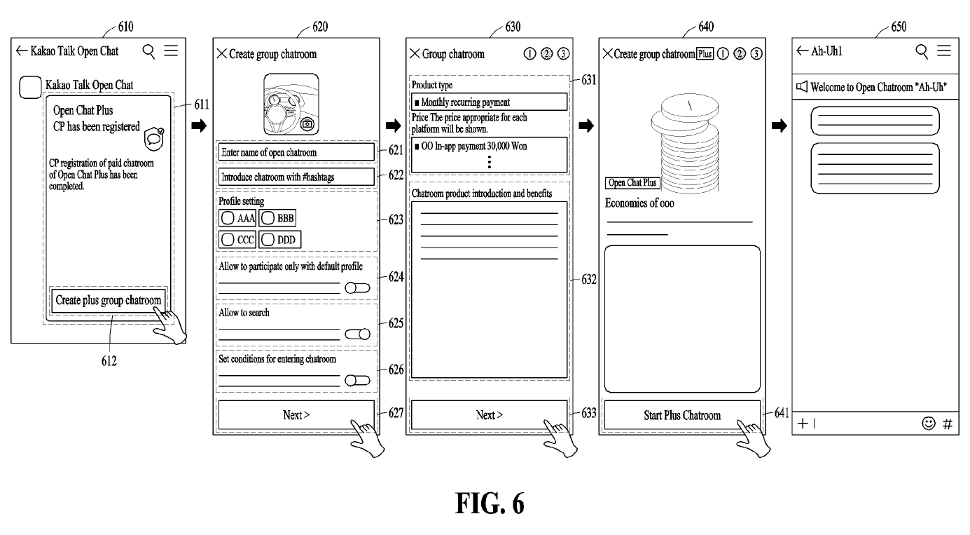

The operation of obtaining the configuration of the chatroom will be described below in more detail with reference to FIG. 6.

In operation 323, the operator terminal 310 may transmit the obtained configuration of the chatroom to the server 330. The server 330 may receive the configuration of the chatroom from the operator terminal 310.

In operation 325, when the server 330 receives the configuration of the chatroom from the operator terminal 310 after obtaining the payment information, the server 330 may generate a chatroom applied with the received configuration. The server 330 may generate the chatroom based on the payment information and the configuration of the chatroom received from the operator terminal 310.

FIG. 4 is a diagram illustrating an example of screens for obtaining a chatroom operation form according to various embodiments.

An operator terminal (e.g., the operator terminal 110 of FIG. 1 or the operator terminal 310 of FIG. 3) according to an embodiment may provide a form filling screen for filling a chatroom operation form by an operator.

On a screen 410, the operator terminal may display a guide screen for a subscription type chatroom. For example, in FIG. 4, the guide screen for the subscription type chatroom may include a guide message 411 for the subscription type chatroom. The guide screen for the subscription type chatroom may include an area 415 for entering a screen to fill a chatroom operation form. When an input to the area 415 is detected, the operator terminal may display a screen 420.

On the screen 420, the operator terminal may perform a process of filling the chatroom operation form for the subscription type chatroom. The operator terminal may display a screen for agreeing to the terms of service for the subscription type chatroom. The operator terminal may display an area 421 for proceeding to a next stage. When an input to the area 421 is detected, the operator terminal may display a screen 430.

On the screen 430, the operator terminal may display a screen for obtaining information about a chatroom. For example, in FIG. 4, the information about the chatroom may include a title of the chatroom, a keyword of the chatroom, a category of the chatroom, an expected operating period of the chatroom, an operating plan of the chatroom and benefits of a chatroom usage pass, and information about an operator, and the screen (e.g., the screen 430) for obtaining the information about the chatroom may include an area 431 for the title (e.g., name) of the chatroom, an area 432 for the keyword (e.g., tag) of the chatroom, an area 433 for the category of the chatroom, an area 434 for the expected operating period of the chatroom, an area 435 for the operating plan of the chatroom and the benefits of the chatroom usage pass, and an area 436 for the information about the operator. The operator terminal may display an area 437 for proceeding to a next stage. When an input to the area 437 is detected, the operator terminal may display a screen 440.

On the screen 440, the operator terminal may display a screen for obtaining information about the chatroom usage pass. For example, in FIG. 4, the information about the chatroom usage pass may include a subscription fee, and the screen for obtaining the information about the chatroom usage pass may include an area 441 for the subscription fee. The operator terminal may include an area 442 for transmitting the chatroom operation form to a server. When an input to the area 442 is detected, the operator terminal may transmit the chatroom operation form including the information about the chatroom and the information about the chatroom usage pass obtained through the screen 430 and the screen 440 to the server.

On a screen 450, when the chatroom operation form is transmitted to the server, the operator terminal may display a guide message indicating that the chatroom operation form is submitted.

Although not explicitly shown in FIG. 4, the server may obtain the chatroom operation form, determine whether to approve the chatroom operation form, and transmit an approval result (e.g., approval or rejection) of the chatroom operation form to the operator terminal.

FIG. 5A is a diagram illustrating an example of screens for registering payment information when a chatroom usage pass subscription system approves a chatroom operation form according to various embodiments.

An operator terminal according to an embodiment (e.g., the operator terminal 110 of FIG. 1 or the operator terminal 310 of FIG. 3) may receive an approval result of the chatroom operation form from a server (e.g., the server 130 of FIG. 1 or the server 330 of FIG. 3). In FIG. 5A, for example, the server may approve the chatroom operation form. When the chatroom operation form is approved, the server may transmit a display command of a guide message regarding the approval of the chatroom operation form to the operator terminal.

On a screen 510a, the operator terminal may display a guide message 511a indicating that the chatroom operation form is approved. According to an embodiment, the server may transmit the guide message 511a indicating that the chatroom operation form is approved to a user terminal through a chatroom of an official account that provides an anonymous chatroom service (or a chatroom usage pass subscription service). The guide message 511a may include an area 512a for entering a registration process of payment information. The operator terminal may detect a user input in the area 512a.

When the user input is detected in the area 512a, on a screen 520a, the operator terminal may perform the registration process of the payment information. The operator terminal may display a screen for agreeing to the terms of service (e.g., agreement on collection and usage of personal information) for the registration of the payment information. The operator terminal may display an area 521a for proceeding to a next stage. The operator terminal may display a screen 530a when an input to the area 521a is detected.

On the screen 530a, the operator terminal may display a screen for obtaining the payment information. In FIG. 5A, for example, the payment information may include store information, calculation manager information, and payment account information. The store information may include at least one of a store (e.g., a store name), a store type (e.g., a business type or personal type), a store identifier (e.g., a business registration number or resident registration number), or business information (e.g., a representative name, business type, industry, postcode, address, or detailed address). The calculation manager information may include a contact (e.g., an email or phone number) of a calculation manager. The payment account information may include a bank identifier (e.g., a bank code), an account number, and a name of depositor. A screen (e.g., the screen 530a) for obtaining the payment information may include at least one of an area 531a for the store information, an area 532a for the calculation manager information, or an area 533a for the payment account information.

FIG. 5B is a diagram illustrating an example of a screen including a guide message when a chatroom usage pass subscription system rejects a chatroom operation form according to various embodiments.

An operator terminal according to an embodiment (e.g., the operator terminal 110 of FIG. 1 or the operator terminal 310 of FIG. 3) may receive an approval result of the chatroom operation form from a server (e.g., the server 130 of FIG. 1 or the server 330 of FIG. 3). In FIG. 5B, for example, the server may reject the chatroom operation form. When the chatroom operation form is rejected, the server may transmit a display command of a guide message 511b regarding the rejection of the chatroom operation form to the operator terminal.

On a screen 510b, the operator terminal may display a guide message 511b indicating the rejection of the chatroom operation form.

FIG. 6 is a diagram illustrating an example of an operation of a chatroom usage pass subscription system obtaining a configuration of a chatroom when payment information is registered according to various embodiments.

An operator terminal according to an embodiment (e.g., the operator terminal 110 of FIG. 1 or the operator terminal 310 of FIG. 3) may receive a display command of a guide message regarding registration of payment information from a server (e.g., the server 130 of FIG. 1 or the server 330 of FIG. 3) based on the registration of the payment information by the server. The operator terminal may display the guide message regarding the registration of the payment information.

On a screen 610, the operator terminal may display a guide message 611 indicating that the payment information is registered. According to an embodiment, the server may transmit the guide message 611 regarding the registration of the payment information to a user terminal through a chatroom of an official account that provides an anonymous chatroom service (or a chatroom usage pass subscription service). The guide message 611 may include an area 612 for proceeding to configuration obtaining process of the chatroom. The operator terminal may detect a user input in the area 612.

On a screen 620, the operator terminal may display a first screen (e.g., a preceding screen) for obtaining the configuration of the chatroom based on the user input detected in the area 612. For example, in FIG. 6, the configuration of the chatroom may include a name of a chatroom, a keyword (e.g., a hashtag) of a chatroom, a profile of an operator account to be used in a chatroom, whether to request participants of a chatroom to participate the chatroom with a specific profile (e.g., a default profile or an anonymous profile), whether to allow search in a chatroom, or conditions for entering a chatroom. The first screen 620 for obtaining the configuration of the chatroom may include an area 621 for the name of the chatroom, an area 622 for the keyword of the chatroom, an area 623 for the profile of the operator account to be used in the chatroom, an area 624 for whether to request participants of the chatroom to participate the chatroom with a specific profile, an area 625 for whether to allow search in the chatroom, and an area 626 for the conditions for entering the chatroom. The operator terminal may display an area 627 for proceeding to a next stage. The operator terminal may detect an input to the area 627.

On a screen 630, the operator terminal may display a second screen (e.g., a following screen) for obtaining the configuration of the chatroom based on a user input detected in the area 627. For example, the second screen for obtaining the configuration of the chatroom may include an area 631 for information (e.g., a product type or price) about the chatroom usage pass and an area 632 for product introduction of the chatroom and benefits of the chatroom usage pass. According to an embodiment, the chatroom usage pass subscription system may restrict changes of the product type (e.g., recurring subscription) of the chatroom usage pass and the subscription fee for the chatroom usage pass after the chatroom operation form is approved. In contrast, the chatroom usage pass subscription system may support changes of at least one of the names of the chatroom, the keyword of the chatroom, an operating plan of the chatroom, or benefits of the chatroom usage pass as the configuration of the chatroom. For example, as shown in FIG. 6, the operator terminal may display the name of the chatroom, the keyword of the chatroom, and the benefits of the chatroom usage pass in a changeable state, and display the product type of the chatroom usage pass and the subscription fee for the chatroom usage pass in a state where the changing is restricted, on the screens 620 and 630. An area 631 on the second screen 630 for obtaining the configuration of the chatroom may be provided to remind the operator of information about the chatroom usage pass before the generation of the chatroom. The operator terminal may display an area 633 for proceeding to a next stage. The operator terminal may detect an input to the area 633.

On a screen 640, the operator terminal may display a preview of a cover screen of the chatroom based on the input detected in the area 633. The cover screen of the chatroom may refer to a screen that provides information about the chatroom to a user account that has not participated in the chatroom. The cover screen of the chatroom may include information about at least one of the name of the chatroom, the benefits of the chatroom usage pass, the subscription fee for the chatroom usage pass, the information about a chatroom operator, or the number of participants of the chatroom. The preview of the cover screen of the chatroom may be generated based on the configuration of the chatroom and/or the information included in the chatroom operation form obtained through the screens 620 and 630. According to an embodiment, the server may generate the preview of the cover screen of the chatroom. The server may transmit a display command of the preview of the cover screen of the chatroom to the operator terminal. The operator terminal may display the preview of the cover screen of the chatroom. When the operator wishes to modify the preview of the cover screen of the chatroom, the operator may return to the screen 620 or the screen 630 to change the configuration of the chatroom. The operator terminal may further display an area 641 for obtaining the generation of the chatroom together with the preview of the cover screen of the chatroom. The operator terminal may detect an input to the area 641.

When the input is detected in the area 641, the operator terminal may transmit the configuration of the chatroom including the information about the chatroom and the information about the chatroom usage pass obtained through the screen 620 and the screen 630 to the server. The server may generate the chatroom based on at least one of the chatroom operation form, the payment information, or the configuration of the chatroom. The operator terminal may display a screen 650 of the generated chatroom.

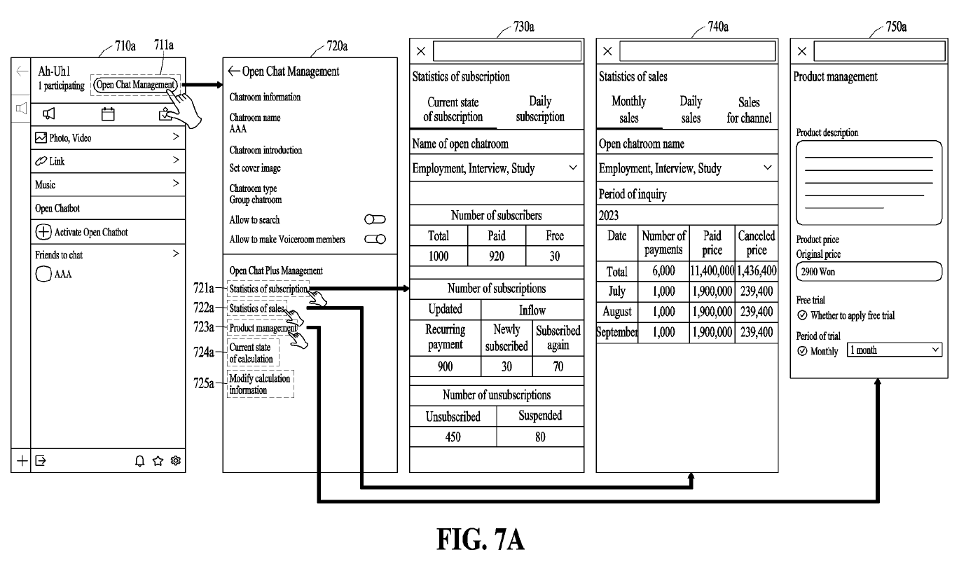

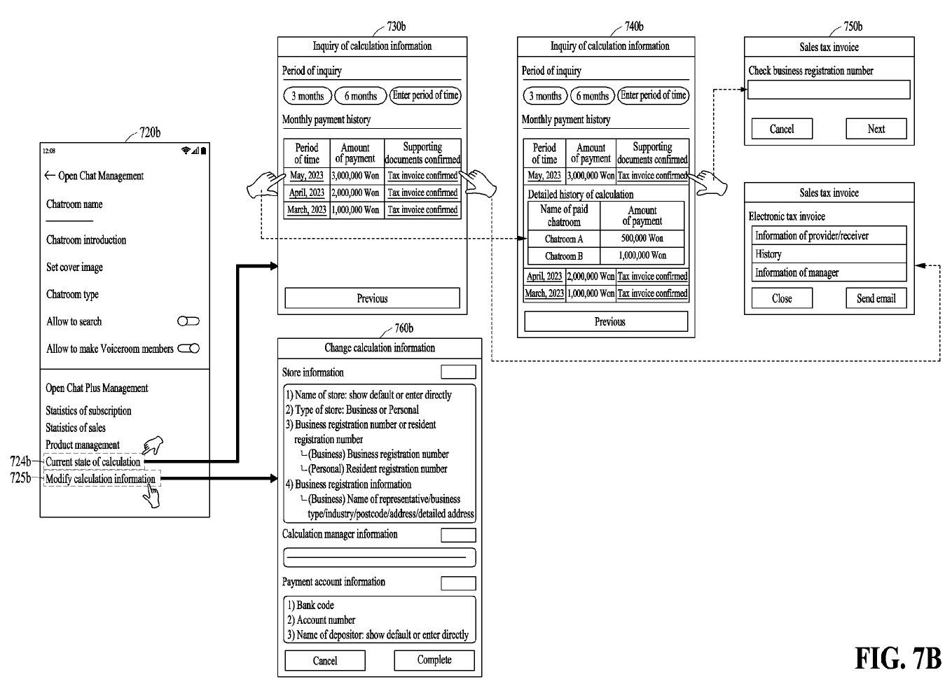

FIGS. 7A and 7B are diagrams illustrating an example of an operation of an operator terminal inquiring about subscription information of a chatroom according to various embodiments.

A chatroom usage pass subscription system according to an embodiment (e.g., the chatroom usage pass subscription system 100 of FIG. 1) may include an operator terminal (e.g., the operator terminal 110 of FIG. 1 or the operator terminal 310 of FIG. 3) and a server (e.g., the server 130 of FIG. 1 or the server 330 of FIG. 3). In the chatroom usage pass subscription system, when the operator terminal requests subscription information for a chatroom usage pass, the server may provide the subscription information for the chatroom usage pass to the operator terminal.

The subscription information may refer to information about subscription to the chatroom usage pass. For example, the subscription information may include information about at least one of one or more subscriber accounts that have subscribed to the chatroom usage pass, a payment history of a subscription fee for the chatroom usage pass, a payment history of revenue based on the subscription fee, or a subscription product corresponding to the chatroom usage pass.

According to an embodiment, the operator terminal may transmit an inquiry request for the subscription information of the chatroom usage pass to the server. The server may receive the inquiry request for the subscription information of the chatroom usage pass from the operator terminal.

The server may transmit a display command of a screen including the subscription information to the operator terminal in response to the inquiry request. The operator terminal may display a screen including the subscription information.

Referring to FIG. 7A, on a screen 710a, the operator terminal may display a menu screen of a chatroom. When the menu screen of the chatroom is displayed by the operator terminal that has accessed with an operator account of the chatroom, the menu screen of the chatroom may include an area 711a for a management screen of the chatroom. For reference, when the menu screen of the chatroom is displayed by a subscriber terminal that has accessed with a subscriber account rather than the operator account of the chatroom, the menu screen of the chatroom does not include the area 711a for the management screen of the chatroom, or a button in the area 711a may be disabled. The operator terminal may detect an input in the area 711a.

On a screen 720a, the operator terminal may display the management screen 720a of the chatroom in response to the input detected in the area 711a. The management screen 720a of the chatroom may include an area for inquiring about the subscription information for the chatroom usage pass based on that the type of the chatroom is a subscription type chatroom. For example, the management screen 720a of the chatroom may include an aera 721a for inquiring about information about a subscriber account of the chatroom usage pass, an area 722a for inquiring about information about a payment history of a subscription fee for the chatroom usage pass, an area 723a for inquiring about information about a subscription product corresponding to the chatroom usage pass, an area 724a for inquiring about information about a payment history of revenue based on the subscription fee for the chatroom usage pass, and an area 725a for inquiring about the payment information.

On a screen 730a, when the operator terminal detects an input in the area 721a, the operator terminal may display the screen 730a for inquiring about information about subscriber accounts of the chatroom usage pass. For example, when the operator terminal detects the input in the area 721a, the operator terminal may transmit an inquiry request for the information about the subscriber accounts of the chatroom usage pass to the server. The server may transmit a display command of the screen 730a including the information about the subscriber accounts of the chatroom usage pass. The operator terminal may display the screen 730a including the information about the subscriber accounts of the chatroom usage pass.

The information about the subscriber accounts of chatroom usage pass may include a result of classifying the subscriber accounts of chatroom usage pass by a history of the subscription to the chatroom usage pass and/or a current state of the subscribers of the chatroom usage pass. For example, the information about the subscriber accounts of the chatroom usage pass may include at least one of the number of current subscribers of the chatroom usage pass, the number of paid subscribers, the number of unpaid subscribers, the number of initial subscribers, the number of regular subscribers, the number of re-subscribers, the number of subscribers who have cancelled the subscription, or the number of subscribers who have suspended subscription.

The number of current subscribers may refer to the number of user accounts having the chatroom usage pass valid at the time of inquiry. The number of paid subscribers may refer to the number of user accounts that have paid for the chatroom usage pass (e.g., paid the subscription fee of a predetermined amount of money or more). The number of unpaid subscribers may refer to user accounts that have purchased the chatroom usage pass for free (e.g., paid the subscription fee of less than a predetermined amount of money). The number of initial subscribers (e.g., first subscription) may refer to the number of user accounts that have subscribed to the chatroom usage pass with no history of the subscription to the chatroom usage pass. The number of regular subscribers may refer to the number of user accounts that have extended the period of use of the chatroom usage pass through the recurring payment. The number of re-subscribers may refer to the number of user accounts that have re-subscribed to the chatroom usage pass with the history of the subscription to the chatroom usage pass and the cancellation thereof. The number of subscribers who have cancelled the subscription may refer to the number of user accounts that have cancelled the subscription to the chatroom usage pass in a predetermined period (e.g., within 1 month from the time of inquiry) from a state of subscribing to the chatroom usage pass. The number of subscribers who have suspended subscription may refer to the number of user accounts that have subscribed to the chatroom usage pass and suspended the subscription (e.g., the recurring payment of the subscription fee and the extension of the period of use).

On a screen 740a, when the operator terminal detects an input in the area 722a, the operator terminal may display the screen 740a for inquiring about information about the payment of the subscription fee for the chatroom usage pass. For example, when the operator terminal detects the input in the area 722a, the operator terminal may transmit an inquiry request for the information about the payment of the subscription fee for the chatroom usage pass to the server. The server may transmit a display command of the screen 740a including the information about the payment of the subscription fee for the chatroom usage pass. The operator terminal may display the screen 740a including the information about the payment of the subscription fee for the chatroom usage pass.

The information about the payment of the subscription fee for the chatroom usage pass may include the amount of money paid as the subscription fee for the chatroom usage pass and/or statistics for the number of payments. For example, the information about the payment of the subscription fee for the chatroom usage pass may include at least one of the number of payments, the amount of money paid, the amount of money cancelled, the amount of refund, or the amount of money calculated. The information about the payment of the subscription fee for chatroom usage pass may include cumulative results based on a predetermined date (e.g., monthly or daily). According to an embodiment, the operator account may operate a plurality of subscription type chatrooms, and the operator terminal (or the chatroom usage pass subscription system) may provide a result of accumulated information about the payment of the subscription fee for the usage pass for each chatroom.

On a screen 750a, when the operator terminal detects an input in the area 723a, the operator terminal may display the screen 750a for inquiring about information about the subscription product corresponding to the chatroom usage pass. For example, when the operator terminal detects an input in the area 723a, the operator terminal may transmit an inquiry request of the information about the subscription product corresponding to the chatroom usage pass to the server. The server may transmit a display command of the screen 750a including the information about the subscription product corresponding to the chatroom usage pass. The operator terminal may display the screen 750a including the information about the subscription product corresponding to the chatroom usage pass.

The information about the subscription product corresponding to the chatroom usage pass may include a description of the subscription product corresponding to the chatroom usage pass, a price (e.g., a subscription fee) for the subscription product, whether to provide a free experience (e.g., free trial), and a period of providing a free trial.

Referring to FIG. 7B, on a screen 720b, the operator terminal may display the management screen 720b (e.g., the screen 720a of FIG. 7A) of the chatroom. As described above with reference to FIG. 7A, the management screen 720b of the chatroom may include an area 724b for inquiring about information about a payment history of revenue based on the subscription fee for the chatroom usage pass, and an area 725b for inquiring about the payment information.

On the screen 720b, when the operator terminal detects an input in the area 724b, the operator terminal may display a screen 730b for inquiring about the information about the payment history of the revenue based on the subscription fee for the chatroom usage pass. For example, when the operator terminal detects an input in the area 724b, the operator terminal may transmit an inquiry request for the information about the payment history of the revenue based on the subscription fee for the chatroom usage pass to the server. The server may transmit a display command of the screen 730b including the information about the payment history of the revenue based on the subscription fee for the chatroom usage pass. The operator terminal may display the screen 730b including the information about the payment history of the revenue based on the subscription fee for the chatroom usage pass.

The information about the payment history of the revenue based on the subscription fee for the chatroom usage pass may include at least one of information about a payment time point of the revenue paid based on the subscription fee (e.g., month of payment), the amount of money of the revenue paid based on the subscription fee (e.g., the amount of money paid), or supporting information of the paid revenue (e.g., tax invoice information).

For example, the information about the payment history of the revenue based on the subscription fee for the chatroom usage pass may include cumulative results based on a predetermined date (e.g., monthly or daily). The operator terminal may obtain an input for designating an inquiry target period (e.g., last three months from the inquiry time point, last six months from the inquiry time point, or a period set according to a user input) for the payment history of the revenue through the screen 730b. The operator terminal may transmit an inquiry request for the information about the payment history of the revenue for the inquiry target period to the server. The server may confirm the information about the paid revenue for the inquiry target period. The server may transmit a display command of a screen including the information about the payment history of the revenue to the operator terminal. The operator terminal may display the screen (e.g., the screen 730b) including the information about the payment history of the revenue.

For example, as shown in the screen 730b of FIG. 7B, the operator terminal may display a screen showing that the revenue paid to the operator account is accumulated each month. Based on detection of a user input in an area corresponding to a particular month (e.g., May), the operator terminal may display a screen 740b on which the revenue paid in the corresponding month is divided for each chatroom.

On the screen 740b, the operator terminal may display the screen 740b including information accumulated by dividing the revenue paid in the selected month (e.g., May) for each chatroom. According to an embodiment, the operator account may operate a plurality of subscription type chatrooms, and the operator terminal (or the chatroom usage pass subscription system) may provide the accumulated result of the information about the payment history of the revenue based on the subscription fee for the chatroom usage pass for each chatroom.

At least one of the screen 730b or the screen 740b may include an area for confirming the supporting information. The operator terminal may display a screen 750b for confirming the supporting information based on detection of a user input in an area for confirming the supporting information for the revenue paid in a particular month.

On the screen 750b, the operator terminal may display the screen 750b for confirming the supporting information. For example, the screen 750b for confirming the supporting information may include an area for inputting a business registration number and/or an input (or registered) business registration number. For example, the screen 750b for confirming the supporting information may include an area for inputting at least one of information about a provider, information about a receiver, a history, or information about a manager and/or the at least one information that is input (or registered).

On a screen 760b, when the operator terminal detects an input in the area 725b, the operator terminal may display the screen 760b for inquiring about the payment information.

On the screen 760b, the operator terminal may display a screen for inquiring and/or modifying the payment information. Similarly to the screen 530a for obtaining the payment information of FIG. 5A, for example, the payment information may include store information, calculation manager information, and payment account information. The store information may include at least one of a shop name (e.g., a store name), a store type (e.g., a business type, personal type), a store identifier (e.g., a business registration number or a resident registration number), or business registration information (e.g., a name of representative, business type, industry, postcode, address, or detailed address). The calculation manager information may include a contact (e.g., an email or phone number) of the calculation manager. The payment account information may include a bank identifier (e.g., a bank code), an account number, and a name of depositor. The screen for obtaining the payment information may include at least one of an area for the store information, an area for the calculation manager information, or an area for the payment account information.

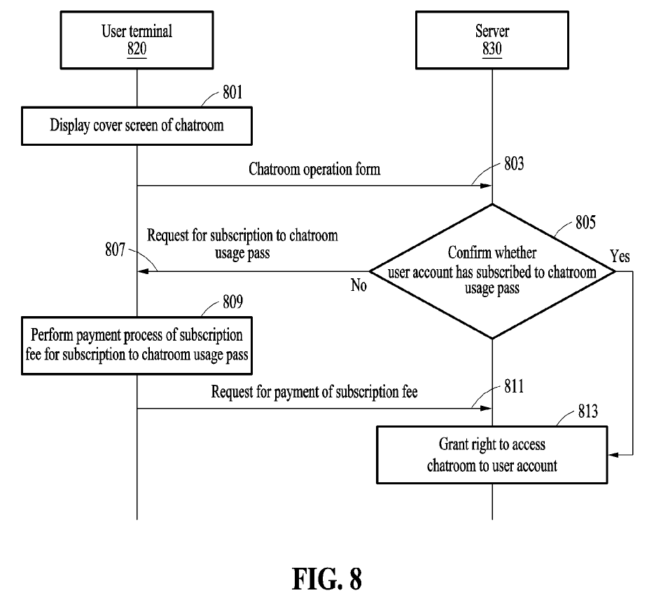

FIG. 8 is a diagram illustrating an example of an operation of a chatroom usage pass subscription system subscribing a chatroom usage pass according to various embodiments.

A chatroom usage pass subscription system according to an embodiment (e.g., the chatroom usage pass subscription system 100 of FIG. 1) may include a user terminal 820 (e.g., the user terminal 120 of FIG. 1) and a server 830 (e.g., the server 130 of FIG. 1 or the server 330 of FIG. 3). The server 830 may cause the user terminal 820 to display an area for entering a cover screen of a subscription type chatroom that is generated and/or operated by an operator account.

In operation 801, the user terminal 820 may display the cover screen of the chatroom. For example, the server 830 may transmit a display command for the area for entering the cover screen of the chatroom to the user terminal 820. The user terminal 820 may display the area for entering the cover screen of the chatroom. An example of the operation of displaying the area for entering the cover screen of the chatroom will be described below in more detail with reference to FIG. 9.

When an input to the area for entering the cover screen of the chatroom is detected, the user terminal 820 may display the cover screen of the chatroom. As described above with reference to FIG. 6, the cover screen of the chatroom may refer to a screen that provides information about the chatroom to a user account that has not participated in the chatroom. For example, the cover screen of the chatroom may include information about at least one of a name of the chatroom, benefits of the chatroom usage pass, the subscription fee for the chatroom usage pass, information about a chatroom operator, or the number of participants of the chatroom.

In operation 803, the user terminal 820 may transmit a request to use the chatroom to the server 830. The server 830 may receive the request to use the chatroom from the user terminal 820.

For example, the user terminal 820 may further display an area for transmitting the request to use the chatroom together with the cover screen of the chatroom. When an input of a user is detected in the area for transmitting the request to use the chatroom, the user terminal 820 may transmit the request to use the chatroom to the server 830.

In operation 805, the server 830 may confirm whether the user account of the user terminal 820 has subscribed to the chatroom usage pass in response to the request to use the chatroom. For example, the information about the user account that has subscribed to the chatroom usage pass may be stored in an internal memory of the server 830 or an accessible external database. The server 830 may determine whether the user account has subscribed to the chatroom usage pass by accessing the internal memory of the server 830 or the external database.

When the user account has subscribed to the chatroom usage pass, the server 830 may grant an access right for the chatroom (e.g., grant the access right for the chatroom in operation 813) to the user account based on the chatroom usage pass subscribed by the user account. When the user account has not subscribed to the chatroom usage pass, the server 830 may provide a process for the subscription to the chatroom usage pass to the user terminal.

In operation 807, when the user account has not subscribed to the chatroom usage pass, the server 830 may transmit a subscription request for the chatroom usage pass to the user terminal 820. The user terminal 820 may receive the subscription request for the chatroom usage pass from the server 830. The subscription request for the chatroom usage pass may include a display command of a guide message for the subscription to the chatroom usage pass and a screen for proceeding to a payment process of the subscription fee for the chatroom usage pass. The user terminal 820 may display the guide message for the subscription to the chatroom usage pass and the screen for proceeding to the payment process of the subscription fee for the chatroom usage pass.

In operation 809, the user terminal 820 may perform the payment process of the subscription fee for the subscription for the chatroom usage pass. The payment process of the subscription fee may include an operation for payment of the subscription fee based on subscription fee information (e.g., the subscription fee indicated by the subscription fee information).

In operation 811, the user terminal 820 may request for the payment of the subscription fee by transmitting the payment information (e.g., card information) to the server 830 (e.g., a payment server 830). The server 830 may attempt the payment of the subscription fee based on the payment information and then transmit a payment approval result to the user terminal 820 and/or the operator terminal.

In operation 813, when the payment for the subscription fee is succeeded, the server 830 may grant the access right for the chatroom to the user account.

The server 830 may set the period of use. When the chatroom usage pass of the subscription type chatroom is provided by the subscription through recurring payment, the server 830 may set a recurring payment date based on the period of use.

The server 830 may set the period of use given to the user account based on a time point at which the payment of the subscription fee is succeeded. The period of use may indicate the validity period of the access right. For example, the period of use may be set to a predetermined period (e.g., 1 month) from the date when the payment of the subscription fee is succeeded. For example, when the date when the payment of the subscription fee is succeeded is December 27, 2023, the period of use may be set from December 27, 2023 to January 26, 2024.

The server 830 may determine the recurring payment date for maintaining the subscription to the chatroom usage pass based on the end date of the set period of use. According to an embodiment, the recurring payment date may be set to the end date (e.g., January 26, 2024) of the period of use, but is not limited thereto, and may be set to the day (e.g., January 27, 2024) before the end date of the period of use or the day (e.g., January 28, 2024) after the end date of the period of use.

The server 830 may extend the period of use based on the recurring payment of the subscription fee. When the recurring payment is succeeded, the server 830 may extend the period of use and change the recurring payment date based on the end date of the extended period of use. When the changed recurring payment date arrives, the server 830 may provide the recurring subscription of the chatroom usage pass by repeating the attempt of the recurring subscription, extension of the period of use, change of the recurring payment date.

When the determined recurring payment date arrives, the server 830 may attempt the recurring payment of the subscription fee for the chatroom usage pass. The chatroom usage pass subscription system according to an embodiment may register the payment information for the recurring payment when performing the payment process of the subscription fee of the user terminal 820. For example, when performing the payment of the subscription fee for the chatroom usage pass, the user terminal 820 may transmit the payment information to be used for first payment (e.g., initial payment) of the subscription fee for the chatroom usage pass and subsequent payment (e.g., recurring payment) of the subscription fee to the server 830. The server 830 may register the payment information received from the user terminal 820 as the payment information of the user account. When the recurring payment date arrives, the server 830 may attempt the recurring payment of the subscription fee for the chatroom usage pass using the payment information registered for the user account.

According to an embodiment, the user may request for the cancellation of the payment of the subscription fee for chatroom usage pass. For example, the user terminal 820 may obtain a cancellation request for the payment of the subscription fee for the chatroom usage pass. The user terminal 820 may transmit the cancellation request for the payment of the subscription fee for the chatroom usage pass to the server 830. The server 830 may receive the cancellation request for the payment of the subscription fee for the chatroom usage pass from the user terminal 820.

The server 830 may determine whether the payment is able to be cancelled based on whether the user account has entered the chatroom. The server 830 may confirm whether the user account has entered the chatroom during the extended period of use based on the payment of the subscription fee corresponding to the cancellation request. When the user account has entered the chatroom, the server 830 may determine that the cancellation of the payment is not possible. When the user account has not entered the chatroom, the server 830 may determine that the cancellation of the payment is possible. When the payment of the subscription fee is cancelled, the server 830 may remove the chatroom usage pass given to the user account. For example, the server 830 may deprive the access right for the chatroom for the user account. According to an embodiment, when the user account has entered the chatroom, the server 830 may determine that the payment of the subscription fee for the chatroom usage pass is not possible, independently of whether a message has received through the chatroom after the user account has entered or whether the user account has sent a message through the chatroom.

According to an embodiment, when the user account has entered the chatroom, the server 830 may determine that the cancellation of the total subscription fee is not possible, and allow the cancellation of some of the subscription fee (e.g., partial cancellation) for a remaining period during the period of use. When some of the subscription fee for the remaining period during the period of use is cancelled (e.g., when the subscription fee is partially cancelled for the remaining period), the server 830 may deprive the access right for the chatroom from the user account.

In various embodiments of the present disclosure, the cancellation of the payment of the subscription fee (or the subscription) may be processed differently depending on the payment method. For example, the payment of the subscription fee may be performed by one of an in-app purchasing method or a web purchasing method. The in-app purchasing method may refer to a method in which a user pays for the subscription fee for the chatroom usage pass through an application (e.g., a payment server) that provides a payment function. The web purchasing method may refer to a method in which a user pays for the subscription fee for the chatroom usage pass without the intervention of an application or other servers.

When a payment cancellation request is received from the user terminal, the server 830 may determine whether the cancellation of the payment is possible. When it is determined that the cancellation of the payment is possible, the server 830 may transmit a cancellation request for the payment for the subscription fee to the payment server. However, when the subscription fee of the user account is paid by the web purchasing method, the user may directly request for the payment cancellation to the server according to the policy of the payment server. In this case, the server 830 may transmit a guide message indicating that the user directly requests for the payment cancellation to the payment server. When the subscription fee of the user account is paid by the in-app purchasing method, the server 830 may request for the payment cancellation instead of the user according to the policy of the payment server. The payment server may cancel some of the subscription fee or total subscription fee. The server 830 may deprive the access right for the chatroom from the user account based on that the payment of some of the subscription fee or total subscription fee is cancelled.

FIG. 9 is a diagram illustrating an example of an operation of a user terminal displaying an area for entering a cover screen of a chatroom according to various embodiments.

A user terminal according to an embodiment (e.g., the user terminal 120 of FIG. 1 or the user terminal 820 of FIG. 8) may receive a display command of an area for entering a cover screen 960 of a chatroom from a server (e.g., the server 130 of FIG. 1, the server 330 of FIG. 3, or the server 830 of FIG. 8), and display the area for entering the cover screen 960 of the chatroom.

On a screen 910, the user terminal may display the screen 910 for a list of participation anonymous chatrooms in which the user account is participating. The screen 910 for the list of the participation anonymous chatrooms may include an area corresponding to subscription type chatrooms in which the user account is participating among the anonymous chatrooms. For example, in FIG. 9, the user account may be in a state of participating in a first subscription type chatroom and a second subscription type chatroom. The server may transmit a display command of the screen 910 including an area 911 corresponding to the first subscription type chatroom and an area 912 corresponding to the second subscription type chatroom to the user terminal. The user terminal may display the screen 910 including the area 911 corresponding to the first subscription type chatroom and the area 912 corresponding to the second subscription type chatroom. Each of the area 911 and the area 912 may include a graphical representation 913 indicating that the area is an area corresponding to a subscription type chatroom.

When an input (e.g., a touch input) to the area 911 or the area 912 is detected, the user terminal may display the cover screen 960 of the subscription type chatroom corresponding to the area where the input is detected. However, the response to the input is not limited to the displaying of the cover screen 960 of the chatroom by the user terminal. When an input is detected in an area corresponding to a subscription type chatroom in which the user account is participating, the user terminal according to an embodiment may skip displaying the cover screen 960 of the chatroom, and display a screen of the chatroom.

On a screen 920, the user terminal may display the screen 920 for a list of recommended anonymous chatrooms recommended to the user account. The screen 920 for the list of recommended anonymous chatrooms may include an area corresponding to a subscription type chatroom recommended to the user account among the anonymous chatrooms. For example, in FIG. 9, the server may recommend the first subscription type chatroom and the second subscription type chatroom to the user account. The server may transmit a display command of the screen 920 including an area 921 for entering the cover screen 960 of the first subscription type chatroom and an area 922 for entering the cover screen 960 of the second subscription type chatroom to the user terminal. The user terminal may display the screen 920 including the area 921 for entering the cover screen 960 of the first subscription type chatroom and the area 922 for entering the cover screen 960 of the second subscription type chatroom. Each of the area 921 and the area 922 may include a graphical representation 923 indicating that the area is an area corresponding to a subscription type chatroom. When an input to the area 921 or the area 922 is detected, the user terminal may display the cover screen 960 of the subscription type chatroom corresponding to the area where the input is detected.

On a screen 930, the user terminal may display the search result screen 930 for anonymous chatrooms. The search result screen 930 for anonymous chatrooms may include an area corresponding to a subscription type chatroom that matches a search request (e.g., a keyword or voice) among the anonymous chatrooms. For example, in FIG. 9, the search result screen 930 for anonymous chatrooms may include an area 931 corresponding to the subscription type chatroom. The server may transmit a display command of the screen 930 including an area 931 for entering the cover screen 960 of the subscription type chatroom to the user terminal. The user terminal may display the screen 930 including the area 931 for entering the cover screen 960 of the subscription type chatroom. The area 931 may include a graphical representation 933 indicating that the area is an area corresponding to a subscription type chatroom. When an input to the area 933 is detected, the user terminal may display the cover screen 960 of the subscription type chatroom corresponding to the area 933.

On a screen 940, the user terminal may display a execution screen 940 of an instant messaging application. The execution screen 940 of the instant messaging application may include, for example, a screen for a list of chatrooms in which the user account is participating. The execution screen 940 of the instant messaging application may include an area 941 for entering the cover screen 960 of the subscription type chatroom. For example, at least a portion of the execution screen 940 may include an advertisement content, and when the execution screen 940 includes an advertisement content of advertising a subscription type chatroom, the area 941 where the advertisement content is displayed may be set as the area 941 for entering the cover screen 960 of the subscription type chatroom. When an input to the area 941 is detected, the user terminal may display the cover screen 960 of the subscription type chatroom corresponding to the area 941.

On a screen 950, the user terminal may obtain an address 951 (e.g., a uniform resource locator (URL) address or a quick response (QR) code) for a subscription type chatroom. The address 951 for the subscription type chatroom may include, for example, an address for the cover screen 960 of the subscription type chatroom. For example, when an input to an area linked to the address 951 for the subscription type chatroom is detected or an image indicating the address for the subscription type chatroom is obtained through a camera of the user terminal, the user terminal may display the cover screen 960 of the subscription type chatroom.

In FIG. 9, it is mainly described that a graphical representation (e.g., the graphical representation 913, the graphical representation 923, or the graphical representation 933) indicating the subscription type chatroom is displayed in the area corresponding to the subscription type chatroom, but embodiments are not limited thereto. For example, the area corresponding to the subscription type chatroom may include a graphical representation corresponding to qualification information of an operator. The qualification information of the operator is information that proves the identity, position, ability, and the like of the operator account, and may include, for example, a driver’s license, a student ID, an employee ID, and other qualifications.

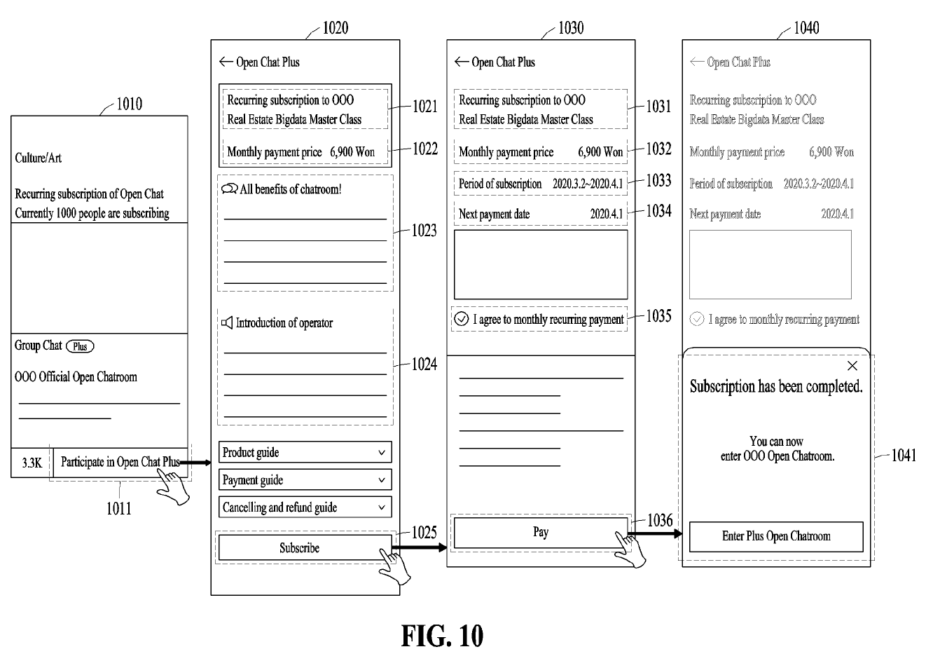

FIG. 10 is a diagram illustrating an example of an operation of a user terminal performing a payment process of a subscription fee for a chatroom usage pass according to various embodiments.

A user terminal according to an embodiment (e.g., the user terminal 120 of FIG. 1 or the user terminal 820 of FIG. 8) may perform a payment process of a subscription fee for a chatroom usage pass for the subscription to the chatroom usage pass.

On a screen 1010, the user terminal may display a cover screen 1010 of a chatroom (e.g., a subscription type chatroom). As described above in FIG. 9, when an input of a user is detected in an area (e.g., the area 911, the area 912, the area 921, the area 922, the area 931, the area 941, or the area 951 of FIG. 9) for entering the cover screen 1010 of the subscription type chatroom, the user terminal may display the cover screen 1010 of the subscription type chatroom. The cover screen 1010 of the subscription type chatroom may include an area 1011 for entering a screen 1020 for guiding information about a chatroom. The user terminal may detect an input of a user. In the area 1011.

On the screen 1020, the user terminal may display the screen 1020 for guiding the information about the chatroom based on the input of the user detected in the area 1011. The screen 1020 for guiding the information about the chatroom may include an area 1021 for the name of the chatroom, an area 1022 for the subscription fee for the chatroom usage pass, an area 1023 for the benefits of the chatroom usage pass, and an area 1024 for the information about the operator. The screen 1020 for guiding the information about the chatroom may include an area 1025 for proceeding to the payment process. The user terminal may detect the input of the user in the area 1025.

On a screen 1030, the user terminal may display the screen 1030 for performing the payment based on the input of the user detected in the area 1025. The screen 1030 for performing the payment may include an area 1031 for the name of the chatroom, an area 1032 for the subscription fee to be paid regularly, an area 1033 for a period of use to be set when the payment of the subscription fee is succeeded, an area 1034 for a recurring payment date to be set when the payment of the subscription fee is succeeded, and an area 1035 for the agreement of the recurring payment. The screen 1030 for performing the payment may include an area 1036 for transmitting a payment request. The user terminal may detect the input of the user in the area 1036. Based on the input of the user detected in the area 1036, the user terminal may request for the payment of the subscription fee for the chatroom usage pass and request for the registration of the recurring payment of the chatroom usage pass by transmitting the payment information (e.g., credit card information) to the server. The server may attempt to register the payment of the subscription fee and/or the recurring payment for the chatroom usage pass. The server may transmit an approval result of the payment of the subscription fee to the user terminal. In FIG. 10, the payment of the subscription fee for the chatroom usage pass by user account may be succeeded.

On a screen 1040, when the payment of the subscription fee is succeeded, the user terminal may display a guide message 1041 indicating that the subscription to the chatroom usage pass is started. For example, when the payment of the subscription fee is succeeded, the server may register the user account as a subscriber account for the chatroom usage pass and/or grant the access right for the chatroom to the user account. When the payment of the subscription fee is succeeded, the server may transmit a display command of the guide message 1041 indicating that the user account has subscribed to the chatroom usage pass.

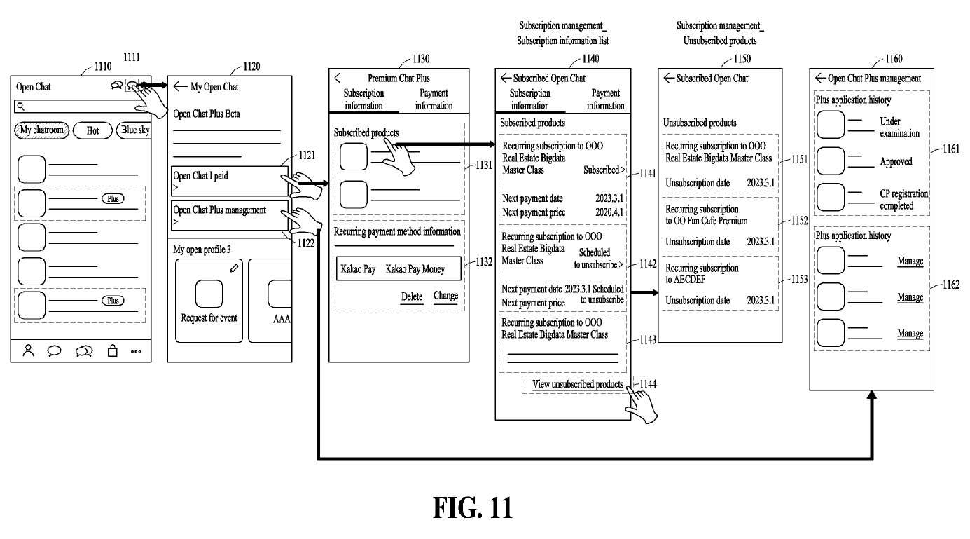

FIG. 11 is a diagram illustrating an example of an operation of a user terminal inquiring about information about a chatroom usage pass subscribed by a user account according to various embodiments.

A chatroom usage pass subscription system according to an embodiment (e.g., the chatroom usage pass subscription system 100 of FIG. 1) may include a user terminal (e.g., the user terminal 120 of FIG. 1 or the user terminal 820 of FIG. 8), and a server (e.g., the server 130 of FIG. 1, the server 330 of FIG. 3, or the server 830 of FIG. 8). In the chatroom usage pass subscription system, when the user terminal requests for information about a chatroom usage pass subscribed by a user account, the server may provide the information about the chatroom usage pass subscribed by the user account to the user terminal.

The user terminal may display an area (e.g., an area 1121 or an area 1131) for an inquiry request for the information about the chatroom usage pass subscribed by the user account. When an input of a user is detected in the area for the inquiry request for the information about the chatroom usage pass subscribed by the user account, the user terminal may transmit the inquiry request for the information about the chatroom usage pass subscribed by the user account. The server may receive the inquiry request for the information about the chatroom usage pass subscribed by the user account from the user terminal. The server may transmit, in response to the inquiry request, a display command of a screen including at least one of a title of a chatroom corresponding to each chatroom usage pass subscribed by the user account, information about an operator account, information about a payment method, a recurring payment date, a subscription fee, or a period of use to the user terminal. When the display command is received, the user terminal may display the screen including at least one of the title of the chatroom corresponding to each chatroom usage pass subscribed by the user account, the information about the operator account, the information about the payment method, the recurring payment date, the subscription fee, or the period of use.

For example, on a screen 1110, the user terminal may display the screen 1110 for a list of participation anonymous chatrooms in which the user account is participating. The screen 1110 for the list of participation anonymous chatrooms may include an area 1111 for inquiring about information about a subscription type chatroom for the user account. The user terminal may detect an input of a user in the area 1111.

On a screen 1120, the user terminal may display the screen 1120 for inquiring about the information about the subscription type chatroom for the user account based on the input of the user detected in the area 1111. The screen 1120 for inquiring about the information about the subscription type chatroom for the user account may include an area 1121 for inquiring about information about the subscription type chatroom subscribed by the user account, and an area 1122 for inquiring about information about a subscription type chatroom operated by the user account.

The subscription type chatroom subscribed by the user account may refer to a subscription chatroom that is generated and/or operated by a user account (e.g., an operator account of the subscription type chatroom) other than the user account, and in which the user account becomes a subscriber account by paying the subscription fee for the chatroom usage pass of the chatroom by the user account. The subscription type chatroom operated by the user account may refer to a chatroom (e.g., a chatroom in which the user account is an operator account) that is generated and/or operated by the user account, and revenue for which based on the subscription fee is paid to the user account as the subscription fee for the chatroom usage pass is paid by a user account other than the user account.

The user terminal may detect an input of a user in the area 1121 or the area 1122.

On a screen 1130, the user terminal may display the screen 1130 for providing the information about the subscription type chatroom subscribed by the user account based on the input of the user detected in the area 1121. The screen 1130 for providing the information about the subscription type chatroom subscribed by the user account may include the area 1131 for the list of the subscription type chatrooms subscribed by the user account and an area 1132 for a recurring payment method of the user account. The area 1132 may include information about the payment method. The user terminal may detect an input of a user in the area 1131.

On a screen 1140, the user terminal may display the screen 1140 for providing the information about each chatroom usage pass subscribed by the user account based on the input of the user detected in the area 1131. The screen 1140 for providing the information about each chatroom usage pass subscribed by the user account may include areas 1141, 1142, and 1143 corresponding to respective chatroom usage passes. For example, when the user account has subscribed to chatroom usage passes of three subscription type chatrooms, the screen 1140 for providing the information about each chatroom usage pass subscribed by the user account may include an area 1141 corresponding to a first chatroom usage pass, an area 1142 corresponding to a second chatroom usage pass, and an area 1143 corresponding to a third chatroom usage pass. The area corresponding to each chatroom usage pass may include a title of a chatroom corresponding to the chatroom usage pass, a subscription state (e.g., subscribed, scheduled to cancel, or suspended) of the chatroom usage pass, a recurring payment date, and a subscription fee (e.g., a next payment price). The screen 1140 for providing the information about each chatroom usage pass subscribed by the user account may include an area 1144 for information about a chatroom usage pass that has unsubscribed by the user account. The user terminal may detect an input of a user in the area 1144.

On a screen 1150, the user terminal may display the screen 1150 for providing information about each chatroom usage pass unsubscribed by the user account based on the input of the user detected in the area 1144. The screen 1150 for providing the information about each chatroom usage pass unsubscribed by the user account may include areas 1151, 1152, and 1153 corresponding to respective chatroom usage passes. For example, when the user account has unsubscribed the chatroom usage passes of three subscription type chatrooms, the screen 1150 for providing the information about each chatroom usage pass unsubscribed by the user account may include the area 1151 corresponding to a fourth chatroom usage pass, the area 1152 corresponding to a fifth chatroom usage pass, and the area 1153 corresponding to a sixth chatroom usage pass. The area corresponding to each chatroom usage pass may include a title of a chatroom corresponding to the chatroom usage pass and a subscription cancellation date of the chatroom usage pass.

Referring back to the screen 1120, the user terminal may detect the input of the user in the area 1122. On a screen 1160, the user terminal may display the screen 1160 for a subscription type chatroom operated by the user account based on the input of the user detected in the area 1122. The screen 1160 for the subscription type chatroom operated by the user account may include an area 1161 for a list of chatroom operation forms written and/or submitted by the user account, and an area 1162 for a list of subscription type chatrooms being operated by the user account. The area 1161 may include an area corresponding to each chatroom operation form. The area corresponding to each chatroom operation form may include a title of a chatroom included in the chatroom operation form and a state of the chatroom operation form (e.g., under examination, approved, suspended (or rejected), payment information registration completed (or CP information registration completed)). The area 1162 may include an area corresponding to each subscription type chatroom being operated by the user account.

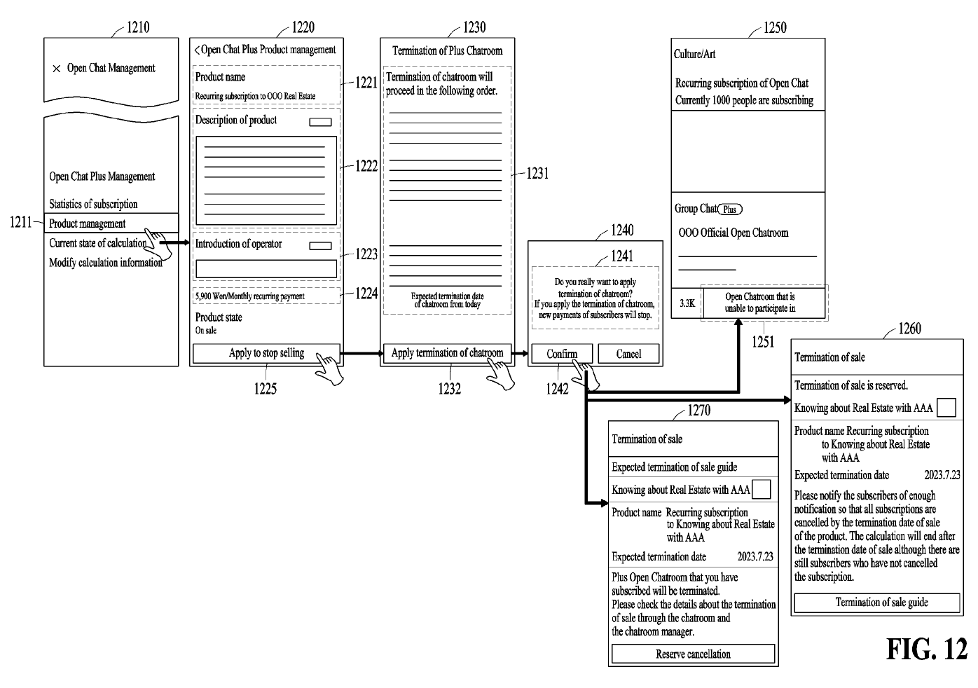

FIG. 12 is a diagram illustrating an example of an operation of a chatroom usage pass subscription system terminating selling a chatroom usage pass according to various embodiments.

A chatroom usage pass subscription system according to an embodiment (e.g., the chatroom usage pass subscription system 100 of FIG. 1) may include an operator terminal (e.g., the operator terminal 110 of FIG. 1 or the operator terminal 310 of FIG. 3), a user terminal (e.g., the user terminal 120 of FIG. 1 or the user terminal 820 of FIG. 8), and a server (e.g., the server 130 of FIG. 1, the server 330 of FIG. 3, or the server 830 of FIG. 8). In the chatroom usage pass subscription system, the operator terminal may terminate the operation of the subscription type chatroom operated by the operator account (e.g., terminate selling the chatroom usage passes).

The operator terminal may transmit an operation termination request for terminating an operation of the chatroom to the server. The server may receive the operation termination request for terminating the operation of the chatroom from the operator terminal.

Referring to FIG. 12, on a screen 1210, the operator terminal may display the screen 1210 for management of a subscription type chatroom operated by the operator account. The screen 1210 for the management of the subscription type chatroom may include an area for management of the chatroom usage pass. When an input of a user (e.g., an operator) is detected in the area 1211, the operator terminal may display a screen 1220 for the management of the chatroom usage pass.

The screen 1220 for the management of the chatroom usage pass may include an area 1221 for a name (e.g., a name or product name) of the chatroom, an area 1222 for description of the chatroom usage pass (e.g., benefits of the chatroom usage pass), an area 1223 for information about an operator account (e.g., introduction of an operator), an area 1224 for information about a subscription fee of the chatroom usage pass, and an area 1225 for operation termination of the chatroom (e.g., termination of selling the chatroom usage pass). When the input of the user (e.g., the operator) is detected in the area 1225, the operator terminal may display a screen 1230 for guide of the operation termination of the chatroom.

The screen 1230 for the guide of the operation termination of the chatroom may include a guide message 1231 for the operation termination of the subscription type chatroom and an area 1232 for the operation termination of the chatroom. When the input of the user (e.g., the operator) is detected in the area 1232, the operator terminal may display a screen 1240 for confirmation of the operation termination request of the chatroom.

The screen 1240 for the confirmation of the operation termination request of the chatroom may include a guide message 1241 regarding operation termination application of the subscription type chatroom and an area 1242 for the operation termination application of the chatroom. When the input of the user (e.g., the operator) is detected in the area 1242, the operator terminal may transmit the operation termination request for the chatroom to the server.

The server may determine an operation termination date of the chatroom in response to the operation termination request. The server may determine the operation termination date of the chatroom using a date a predetermined period of time has elapsed from a time point at which the operation termination request is received. The predetermined period of time may be determined based on a cycle of recurring payments. For example, when the chatroom usage pass is a subscription product with a monthly recurring payment, the operation termination date may be determined one month after the time point at which the operation termination request is received. However, the operation termination date according to various embodiments is not limited to being determined using the date the predetermined period of time has elapsed from the time point at which the operation termination request is received. According to an embodiment, the server may determine the operation termination date based on a validity period (e.g., a period of use) of the chatroom usage pass of a subscriber account that has subscribed to the chatroom usage pass. For example, the server may determine a latest day of termination date of the period of use of the chatroom usage pass of the subscriber account as the operation termination date.

When the determined operation termination date arrives, the server may remove the subscriber account from the chatroom. When the operation termination date arrives, the server may allow the operator account to leave the chatroom. As described above with reference to FIG. 2, in principle, the chatroom usage pass subscription system according to an embodiment may restrict the operator account of the subscription type chatroom from leaving the subscription type chatroom, however, when the operation termination application of the subscription type chatroom is received and the operation termination date arrives, the server may allow the leaving of the operator account.

According to an embodiment, the server may cancel the recurring payment of the subscriber account in response to the operation termination request. The server may cancel the recurring payment of the subscription fee for the chatroom usage pass registered for the subscriber account that has subscribed to the chatroom usage pass. In other words, although the recurring payment date of the chatroom usage pass set for each subscriber account arrives, the server may not perform the payment (e.g., the recurring payment or additional payment) of the subscription fee.

However, the server according to various embodiments is not limited to collectively cancelling of the recurring payment of the subscriber account in response to the operation termination request. According to an embodiment, the server may induce a subscriber to directly cancel the recurring payment by transmitting a recurring payment cancellation request (e.g., a display command of a guide message for the cancelling of the recurring payment) for the cancelling of the recurring payment of the subscriber account to a subscriber terminal (e.g., the user terminal).

The server according to an embodiment may restrict application of subscription to the chatroom usage pass by changing a cover screen 1250 of the chatroom in response to the operation termination request. The server may transmit a display command of a guide message 1260 showing that the operation termination application of the chatroom is received to the operator terminal in response to the operation termination request. The server may transmit a display command of a guide message 1270 showing the operation termination of the chatroom to the user terminal in response to the operation termination request.

Referring to FIG. 12, the operator terminal may detect an input of a user (e.g., the operator) in the area 1242 of the screen 1240. The server may change the cover screen 1250 of the chatroom in response to a case where the operation termination request is received from the operator terminal. The cover screen 1250 of the chatroom may include a graphical representation 1251 indicating that the application of the subscription to the chatroom usage pass is not possible.

The server may transmit the guide message 1260 showing that the operation termination application of the chatroom is received to the operator terminal through a chatroom of an official account that provides an anonymous chatroom service (or the chatroom usage pass subscription service). The operator terminal may display the guide message 1260.

The server may transmit the guide message 1270 for the operation termination of the chatroom to the user terminal (e.g., the subscriber terminal) through the chatroom of the official account that provides the anonymous chatroom service (or the chatroom usage pass subscription service). The user terminal may display the guide message 1270.

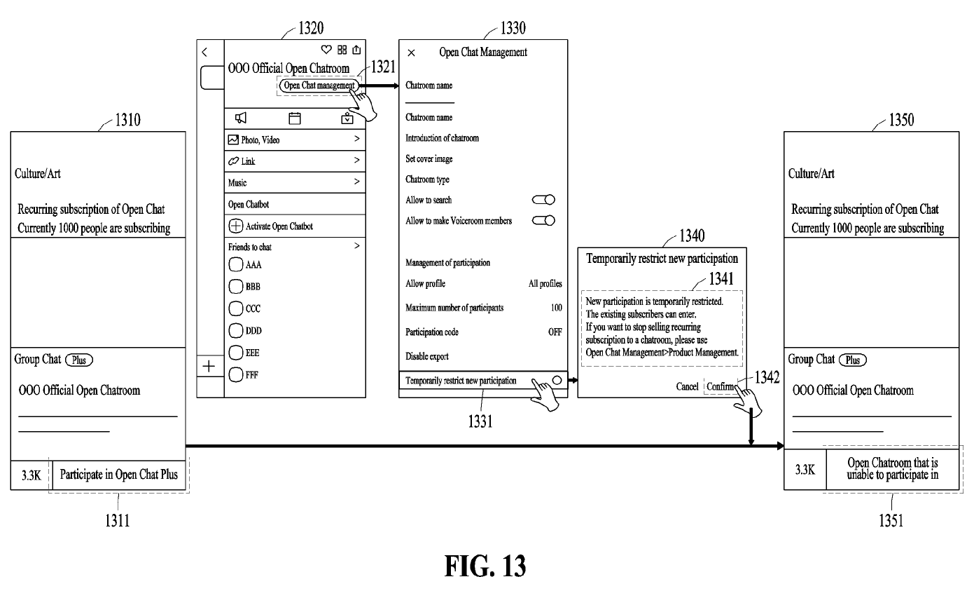

FIG. 13 is a diagram illustrating an example of an operation of a chatroom usage pass subscription system restricting new subscription to the chatroom usage pass according to various embodiments.

A chatroom usage pass subscription system according to an embodiment (e.g., the chatroom usage pass subscription system 100 of FIG. 1) may include an operator terminal (e.g., the operator terminal 110 of FIG. 1 or the operator terminal 310 of FIG. 3), a user terminal (e.g., the user terminal 120 of FIG. 1 or the user terminal 820 of FIG. 8), and a server (e.g., the server 130 of FIG. 1, the server 330 of FIG. 3, or the server 830 of FIG. 8). In the chatroom usage pass subscription system, the operator terminal may restrict new subscription to the chatroom usage pass of a subscription type chatroom operated by an operator account. The new subscription to the chatroom usage pass may refer to that a user account that has not subscribed to the chatroom usage pass, that is, a user account that does not have an access right for the chatroom obtains the access right for the chatroom by subscribing to the chatroom usage pass.

The operator terminal may transmit a new subscription restriction request for restricting the new subscription to the chatroom usage pass to the server. The server may receive the new subscription restriction request for restricting the new subscription to the chatroom usage pass from the operator terminal.

Whether the new subscription to the chatroom usage pass is restricted may be recognized by a user through a cover screen of a chatroom. For example, in FIG. 13, a cover screen 1310 of a chatroom may include a first graphical representation 1311 indicating that the new subscription to the chatroom is possible.

Referring to FIG. 13, the operator terminal may display a menu screen 1320 of the chatroom. When the menu screen of the chatroom is displayed by an operator terminal accessed as an operator account of the chatroom, the menu screen of the chatroom may include an area 1321 for a management screen of the chatroom. The operator terminal may detect an input in the area 1321.

On a screen 1330, the operator terminal may display the management screen 1320 of the chatroom in response to the input detected in the area 1321. The management screen 1330 of the chatroom may include an area 1331 for restricting the new subscription to the chatroom usage pass. The operator terminal may detect an input in the area 1331.

On a screen 1340, the operator terminal may display the screen 1340 for confirming the restriction of the new subscription in response to the input detected in the area 1331. The screen 1340 for confirming the restriction of the new subscription may include a guide message 1341 regarding the restriction of the new subscription and an area 1342 for applying the restriction of the new subscription. The operator terminal may detect the input in the area 1342. The operator terminal may transmit a new subscription restriction request to the server based on the input detected in the area 1342.

The server may set to restrict the new subscription to the chatroom usage pass in response to the new subscription restriction request. For example, the server may change a first graphic representation 1311 on the cover screen 1310 of the chatroom to a second graphic representation 1351 indicating that the new subscription to the chatroom is restricted to obtain a changed cover screen 1350. The user may recognize that the new subscription to the chatroom is restricted through the changed cover screen 1350. Although not explicitly shown in FIG. 13, when the restriction of the new subscription is released by the operator terminal, as the second graphic representation 1351 on the cover screen 1350 is replaced with the first graphic representation 1311, the cover screen of the chatroom may be switched to the cover screen 1310 indicating that the new subscription is possible.

When the access request for the chatroom, to which the new subscription is restricted, is received from the user terminal and the user account has not subscribed to the chatroom usage pass, the server may transmit a display command of a guide message showing that the new subscription to the chatroom usage pass is restricted to the user terminal. The user terminal may display the guide message showing that the new subscription to the chatroom usage pass is restricted.

Although the new subscription to the chatroom is restricted, the chatroom usage pass subscription system according to an embodiment may maintain providing the chatroom to the subscriber that has already subscribed to the chatroom usage pass. For example, the server may maintain the access right for the chatroom of an existing subscriber account by repeating the extension of the recurring payment of the subscription fee and the period of use for the existing subscriber account that has subscribed to the chatroom usage pass before the new subscription restriction request.

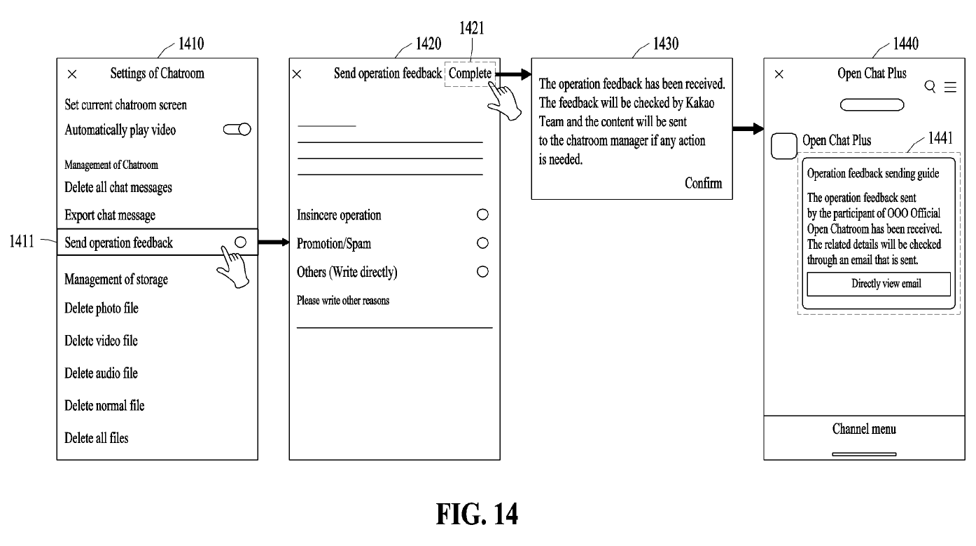

FIG. 14 is a diagram illustrating an example of an operation of a chatroom usage pass subscription system sending feedback of a subscriber to an operator according to various embodiments.

A chatroom usage pass subscription system according to an embodiment (e.g., the chatroom usage pass subscription system 100 of FIG. 1) may include an operator terminal (e.g., the operator terminal 110 of FIG. 1 or the operator terminal 310 of FIG. 3), a user terminal (e.g., the user terminal 120 of FIG. 1 or the user terminal 820 of FIG. 8), and a server (e.g., the server 130 of FIG. 1, the server 330 of FIG. 3, or the server 830 of FIG. 8). In the chatroom usage pass subscription system, a subscriber that has subscribed to the chatroom usage pass may send feedback for the operation of the chatroom to an operator.

In FIG. 14, on a screen 1410, a subscriber terminal may display a menu screen 1410 of a chatroom. The menu screen 1410 of the chatroom may include an area 1411 for feedback on the operation of the chatroom.

On a screen 1420, when an input of a user (e.g., a subscriber) is detected in the area 1411, the subscriber terminal may display the screen 1420 for inputting the feedback on the operation of the chatroom. The subscriber terminal may obtain the feedback on the operation of the chatroom through the screen 1420. The screen 1420 may further include an area 1421 for sending feedback on the operation of the chatroom.

On a screen 1430, the subscriber terminal may display the guide message 1430 showing that the feedback is sent based on the detection of the input of the user (e.g., the subscriber) in the area 1421.

The subscriber terminal may send feedback information to the server based on the input detected in the area 1421. The server may send the feedback information to the operator terminal. For example, the server may transmit a guide message 1441 regarding the feedback on the operation of the chatroom to the user terminal through a chatroom of an official account that provides an anonymous chatroom service (or the chatroom usage pass subscription service).

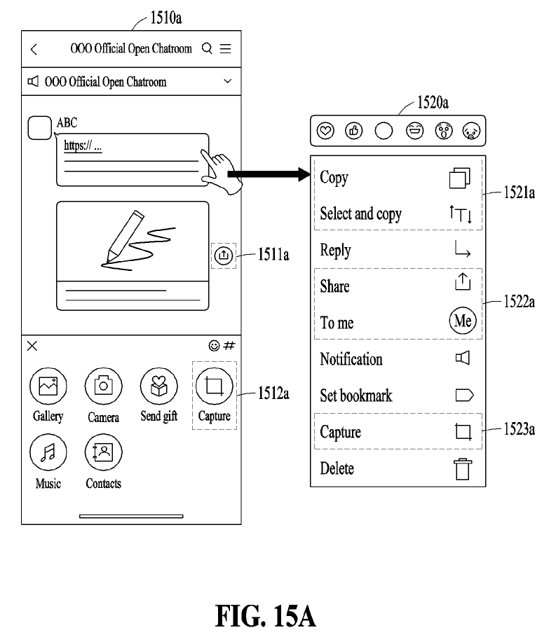

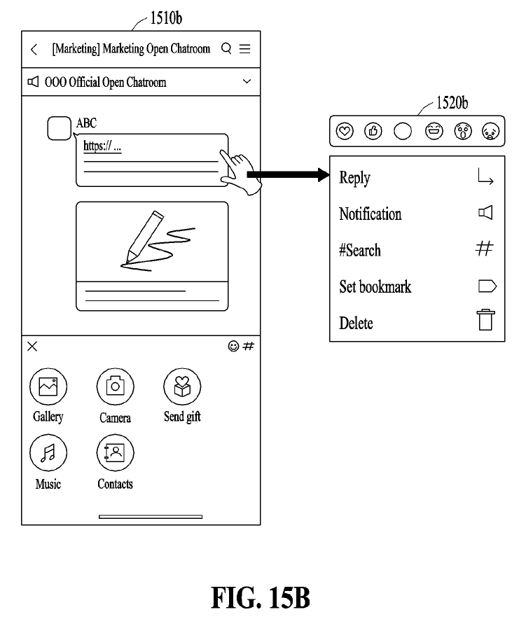

FIGS. 15A and 15B are diagrams illustrating an example of an operation of a chatroom usage pass subscription system providing a screen of a normal chatroom or a non-subscription type anonymous chatroom and a screen of a subscription type chatroom according to various embodiments.

A chatroom usage pass subscription system according to an embodiment (e.g., the chatroom usage pass subscription system 100 of FIG. 1) may include an operator terminal (e.g., the operator terminal 110 of FIG. 1 or the operator terminal 310 of FIG. 3), a user terminal (e.g., the user terminal 120 of FIG. 1 or the user terminal 820 of FIG. 8), and a server (e.g., the server 130 of FIG. 1, the server 330 of FIG. 3, or the server 830 of FIG. 8). In the chatroom usage pass subscription system, in the subscription type chatroom, at least a portion of functions of a normal chatroom or a non-subscription type anonymous chatroom may be restricted.

The type of chatroom may be determined as one of an anonymous chatroom (or an anonymous chatroom type) or a normal chatroom (or a normal chatroom type). The anonymous chatroom type may be classified as one of a non-subscription type anonymous chatroom (or a non-subscription type anonymous chatroom type) or a subscription type anonymous chatroom (or a subscription type anonymous chatroom type) (in the disclosure, also referred to as a “subscription type chatroom” or a “subscription type chatroom type”).

The anonymous chatroom may refer to a chatroom participating through a temporary profile rather than an account based on a real name. The normal chatroom is a chatroom other than the anonymous chatroom, and may include, for example, a chatroom participating through a profile corresponding to an account based on the real name. The subscription type anonymous chatroom may refer to an anonymous chatroom, for which the access right is granted to the user account that has subscribed to the chatroom usage pass. The non-subscription type anonymous chatroom may refer to an anonymous chatroom, for which the access right is granted to the user account, independently (regardless) of the chatroom usage pass.

Referring to FIG. 15A, when the user account participates in the normal chatroom or the non-subscription type anonymous chatroom, the server may provide a sharing function, a copying function, or a capturing function of messages transmitted and received through the normal chatroom or the non-subscription type anonymous chatroom. FIG. 15A, the user terminal may display a screen 1510a of a normal chatroom or a non-subscription type anonymous chatroom, in which the user account is participating. The server may display the screen 1510a for providing the sharing function, the copying function, and the capturing function in the normal chatroom or the non-subscription type anonymous chatroom. The user terminal display a screen 1520a for providing a list of functions for messages based on the detection of an input (e.g., an input that maintains touch for a threshold time length, a long press input) for the messages. The screen 1510a may include an area 1511a for the sharing function and an area 1512a for the capturing function. The screen 1520a may include an area 1521a for the copying function, an area 1522a for the sharing function, and an area 1523a for the capturing function.

Referring to FIG. 15B, when the user account participates in the subscription type chatroom, the server may restrict at least one of the sharing function, the copying function, or the copying function of messages transmitted and received through the subscription type chatroom. In FIG. 15B, the user terminal may display a screen 1510b of the subscription type chatroom in which the user account has participated. The server may display the screen 1510b, in which the sharing function, the copying function, and the capturing function are restricted, in the subscription type chatroom. The user terminal may display a screen 1520b for providing the list of functions for messages based on the detection of an input (e.g., a long press input, an input that maintains touch for a threshold time length) for the messages. The screen 1510b may not include an area for the sharing function (e.g., the area 1511a of FIG. 15A) and an area for the capturing function (e.g., the 1512a of FIG. 15A). The screen 1520b may not include an area for the copying function (e.g., the area 1521a of FIG. 15A), an area for the sharing function (e.g., the area 1522a of FIG. 15A), and an area for the capturing function (e.g., the area 1523a of FIG. 15A).

In FIG. 15B, it has been mainly described that the user terminal displays the screen not including the area corresponding to at least one of the sharing function, the copying function, or the capturing function, but embodiments are not limited thereto. The user terminal according to an embodiment may display the screen including the area corresponding to at least one of the sharing function, the copying function, or the capturing function. As each area is included in a disabled state on the screen, the server may provide the screen of the subscription type chatroom in which at least one of the sharing function, the copying function, or the capturing function is restricted to the user terminal.

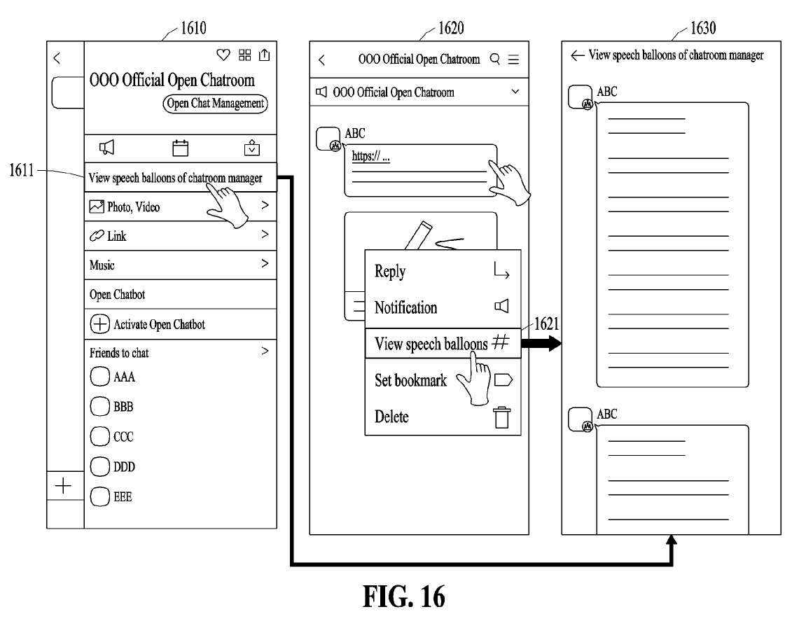

FIG. 16 is a diagram illustrating an example of an operation of a chatroom usage pass subscription system providing a function of extracting a message of an operator according to various embodiments.

A chatroom usage pass subscription system according to an embodiment (e.g., the chatroom usage pass subscription system 100 of FIG. 1) may include an operator terminal (e.g., the operator terminal 110 of FIG. 1 or the operator terminal 310 of FIG. 3), a user terminal (e.g., the user terminal 120 of FIG. 1 or the user terminal 820 of FIG. 8), and a server (e.g., the server 130 of FIG. 1, the server 330 of FIG. 3, or the server 830 of FIG. 8). In the chatroom usage pass subscription system, a function of displaying a screen, on which messages sent by an operator are extracted from messages sent through a subscription type chatroom (e.g., a function of viewing messages from the operator, a function of viewing speech balloons of a chatroom manager) may be provided.

The operator terminal or the user terminal may transmit a request for extracting and displaying messages sent by an operator account to the server. The server may receive the request for extracting and displaying messages sent by the operator account from at least one terminal of the operator terminal or the user terminal.

The server may extract the messages sent by the operator account through a chatroom in response to the received request. The server may transmit a display command of a screen including the messages extracted from the at least one terminal. The operator terminal or the user terminal may display a screen including the extracted messages.

Referring to FIG. 16, on a screen 1610, the operator terminal or the user terminal may display the menu screen 1610 of the chatroom. The menu screen 1610 of the chatroom may include an area 1611 for a function of displaying the screen of the extracted messages sent by an operator. The operator terminal or the user terminal may transmit the request for extracting and displaying the messages sent by the operator account to the server based on an input detected in the area 1611.

On a screen 1620, the operator terminal or the user terminal may display the screen 1620 including a list of functions for a message based on detection of an input (e.g., an input that maintains touch for a threshold time length, a long press input) for a message on the screen of the chatroom. When the message is a message sent by the operator, the screen 1620 including the list of functions for the message may include an area 1621 for a function of displaying the screen of the extracted messages sent by the operator. The operator terminal or the user terminal may transmit the request for extracting and displaying the message sent by the operator account to the server based on an input detected in the area 1621.

When the request for extracting and displaying the message sent by the operator account is received from the operator terminal or the user terminal, the server may extract the message sent by the operator account through the chatroom. The server may transmit a display command of the screen 1630 including the extracted message to the operator terminal or the user terminal.

The operator terminal or the user terminal may display the screen 1630 including the extracted message.

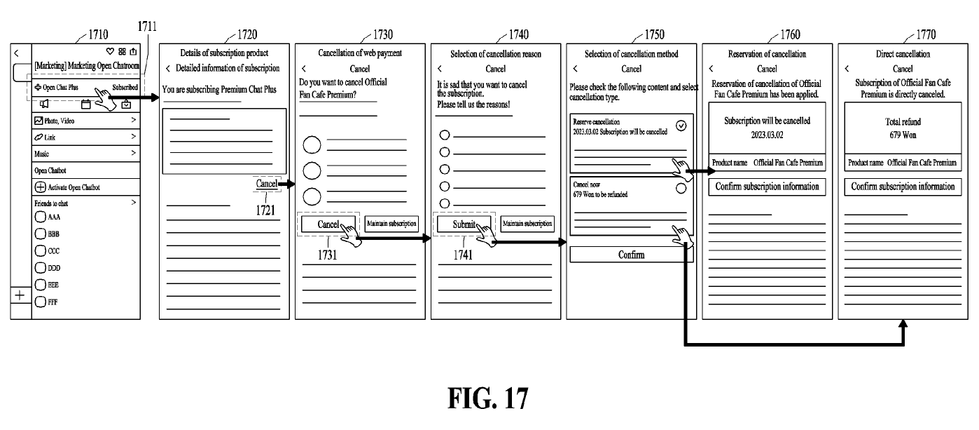

FIG. 17 is a diagram illustrating an example of an operation of a subscriber terminal cancelling subscription to a chatroom usage pass according to various embodiments.

A chatroom usage pass subscription system according to an embodiment (e.g., the chatroom usage pass subscription system 100 of FIG. 1) may include an operator terminal (e.g., the operator terminal 110 of FIG. 1 or the operator terminal 310 of FIG. 3), a user terminal (e.g., the user terminal 120 of FIG. 1 or the user terminal 820 of FIG. 8), and a server (e.g., the server 130 of FIG. 1, the server 330 of FIG. 3, or the server 830 of FIG. 8). In the chatroom usage pass subscription system, a subscriber may cancel the subscription to the chatroom usage pass to which the subscriber has subscribed.

On a screen 1710, the subscriber terminal may display the menu screen 1710 of the chatroom. The menu screen 1710 of the chatroom may include an area 1711 for providing information about the chatroom usage pass.

On a screen 1720, when an input of a user (e.g., a subscriber) is detected in the area 1711, the subscriber terminal may display the screen 1720 for providing the information about the chatroom usage pass. The screen 1720 for providing the information about the chatroom usage pass may include an area 1721 for proceeding to a subscription cancellation process of the chatroom usage pass.

On a screen 1730, when the input of the user (e.g., the subscriber) is detected in the area 1721, the subscriber terminal may perform an operation included in the subscription cancellation process. First, the subscriber terminal may display a guide screen 1730 regarding the subscription cancellation of the chatroom usage pass. The guide screen 1730 regarding the subscription cancellation of the chatroom usage pass may include an area 1731 for proceeding to a next stage.

On a screen 1740, when an input of the user (e.g., the subscriber) is detected in the area 1731, the subscriber terminal may display the screen 1740 for inputting a reason for the subscription cancellation. The screen 1740 for inputting a reason for the subscription cancellation may include an area 1741 for proceeding to a next stage.

On a screen 1750, when an input of the user (e.g., the subscriber) is detected in the area 1741, the subscriber terminal may display the screen 1750 for selecting a cancellation method. The chatroom usage pass subscription system according to an embodiment may provide a cancellation reservation and immediate cancellation as a subscription cancellation method of the chatroom usage pass. The cancellation reservation may refer to a method of maintaining the access right of a user account for the chatroom during a remaining period of use of the chatroom usage pass, depriving the access right without the recurring payment when the termination date of the period of use arrives. The immediate termination (e.g., the direct cancellation) may refer to a method of determining a refund amount of the subscription fee for the remaining period of use of the chatroom usage pass, and changing (e.g., bringing forward) the termination date of the period of use to a cancellation application date according to the refund of the payment fee.

On a screen 1760, when the cancellation reservation is selected by the method of the subscription cancellation, the subscriber terminal may display the screen 1760 for providing information about the subscription cancellation. The information about the subscription cancellation may include an expected cancellation date. According to an embodiment, the expected cancellation date may be set as the termination date of the period of use of the chatroom usage pass.

On a screen 1770, when the immediate cancellation is selected as the method of the subscription cancellation, the subscriber terminal may display the screen 1770 for providing information according to the immediate cancellation. The information about the immediate cancellation may include a refund amount. According to an embodiment, the refund amount may be determined as an amount of money obtained by multiplying an amount of subscription fee calculated by day based on the cycle (e.g., 30 days) of the recurring payment by days of the remaining period of use.

The subscriber terminal may transmit the subscription cancellation request for the chatroom usage pass to the server based on that the input is obtained through the screen 1760 or the screen 1770. The server may delete the recurring payment date of the subscriber account based on the reception of the subscription cancellation request from the subscriber terminal, and change a subscription state of the subscriber account to a cancellation reservation state or a cancellation completion state in a state of “subscribed.”

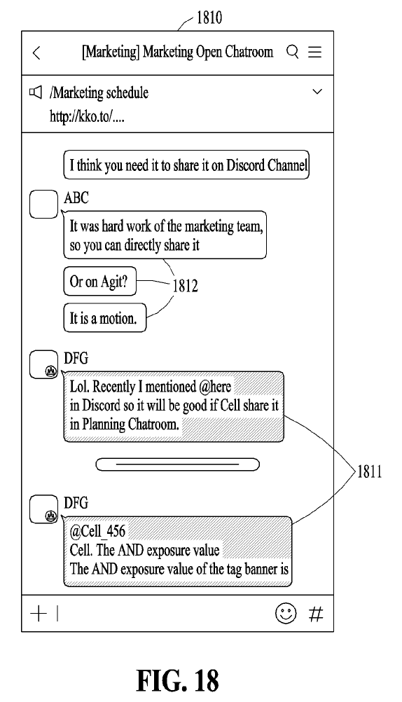

FIG. 18 is a diagram illustrating an example of an operation of a chatroom usage pass subscription system providing a function of applying a visual effect to a message sent by an operator account according to various embodiments.

A chatroom usage pass subscription system according to an embodiment (e.g., the chatroom usage pass subscription system 100 of FIG. 1) may include an operator terminal (e.g., the operator terminal 110 of FIG. 1 or the operator terminal 310 of FIG. 3), a user terminal (e.g., the user terminal 120 of FIG. 1 or the user terminal 820 of FIG. 8), and a server (e.g., the server 130 of FIG. 1, the server 330 of FIG. 3, or the server 830 of FIG. 8). In the chatroom usage pass subscription system, a screen of a subscription type chatroom may include messages sent and received through the subscription type chatroom, and a visual effect may be applied to a message sent by an operator account of the subscription type chatroom among messages.

The server may transmit a display command of a screen of a chatroom in which the visual effect is applied to the message sent by the operator account, to at least one terminal of the operator terminal or the user terminal. The visual effects may include, for example, at least one of an attribute (e.g., a size, color, or shape) of a speech bubble object corresponding to a message or an attribute (e.g., a font, size, bold, italics, or underscore) of characters corresponding to the message.

For example, the server may instruct at least one terminal of the operator terminal or the user terminal to apply a first visual effect to the message sent by the operator account and apply a second visual effect to the message sent by a user account (e.g., a subscriber account) different from the operator account. For example, the server may instruct at least one terminal of the operator terminal or the user terminal to display a message sent by the operator account as characters with a first font and a first size, and display a message sent by the subscriber account as characters with a second font and a second size (e.g., a size smaller than the first size).

Referring to FIG. 18, on a screen 1810, the operator terminal or the user terminal may display a screen of a chatroom. The operator terminal or the user terminal may display speech bubbles 1811 of messages sent by the operator account in a different color of speech bubbles 1812 of messages sent by the subscriber account.

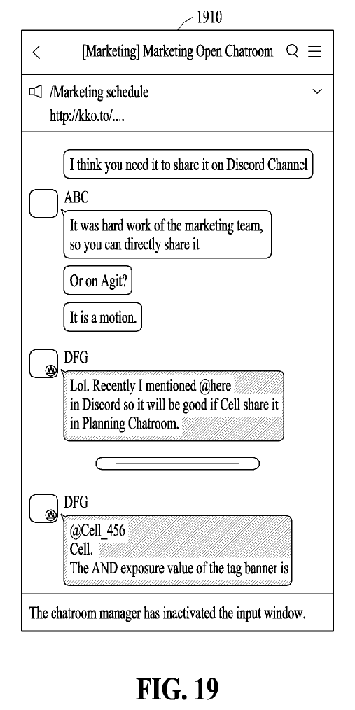

FIG. 19 is a diagram illustrating an example of an operation of a chatroom usage pass subscription system determining an account capable of sending a message through a subscription type chatroom according to various embodiments.

A chatroom usage pass subscription system according to an embodiment (e.g., the chatroom usage pass subscription system 100 of FIG. 1) may include an operator terminal (e.g., the operator terminal 110 of FIG. 1 or the operator terminal 310 of FIG. 3), a user terminal (e.g., the user terminal 120 of FIG. 1 or the user terminal 820 of FIG. 8), and a server (e.g., the server 130 of FIG. 1, the server 330 of FIG. 3, or the server 830 of FIG. 8). In the chatroom usage pass subscription system, a user account that may send a message through a subscription type chatroom may be determined by an operator.

According to an embodiment, an operating mode of a chatroom may correspond to a range of a user account that may write and/or send messages through the chatroom. For example, when the operating mode of the chatroom is a first mode, the server may restrict the user account that may write and/or send messages through the chatroom as an operator account. When the operating mode of the chatroom is a second mode, the server may grant a right to write and/or send a message through the chatroom to a user account that has entered the chatroom (e.g., an operator account and a subscriber account that has participated in the chatroom).

The operator terminal may obtain an input of a user (e.g., an operator) for determining (e.g., changing, switching, or modifying) the operating mode of the subscription type chatroom operated by the operator account. The operator terminal may display a screen for managing the subscription type chatroom. The screen for managing the chatroom may include an area for determining the operating mode of the chatroom. The operator terminal may detect an input of the user (e.g., the operator) for determining the operating mode of the chatroom as one of a first mode or a second mode through the area for determining the operating mode of the chatroom. When the input of the user for determining the operating mode is detected, the operator terminal may transmit an operating mode determination request to the server.

The server may determine the operating mode of the chatroom as one of a first mode of restricting a user account having the right to send the message through the chatroom as the operator account or the second mode of granting the right to send the message to the user account that has entered the chatroom in response to the operating mode determination request received from the operator terminal.

The server may instruct the user terminal (e.g., a subscriber terminal) to display a screen on which a function of sending a message through the chatroom is restricted while the operating mode of the chatroom is the first mode. The server may instruct the user terminal (e.g., the subscriber terminal) to display a screen on which the function of sending a message through the chatroom is allowed while the operating mode of the chatroom is the second mode.

The server may instruct the operator terminal to display the screen on which the function of sending a message through the chatroom, independent of the operating mode of the chatroom.

Referring to FIG. 19, the user terminal may display a screen 1910 on which the function of sending a message through the chatroom is restricted while the operating mode of the chatroom is the second mode.

Although not explicitly shown in FIG. 19, the operator terminal may transmit an operation mode determination request for switching the operating mode of the chatroom from the second mode to the first mode to the server. The server may switch the operating mode of the chatroom from the second mode to the first mode. The server may instruct the user terminal (e.g., the subscriber terminal) to display the screen on which the function of sending a message through the chatroom is allowed. The user terminal (e.g., the subscriber terminal) may display the screen on which the function of sending a message through the chatroom is allowed while the operating mode of the chatroom is the first mode. For example, the user terminal (e.g., the subscriber terminal) may send the message through the chatroom while the operating mode of the chatroom is the first mode.

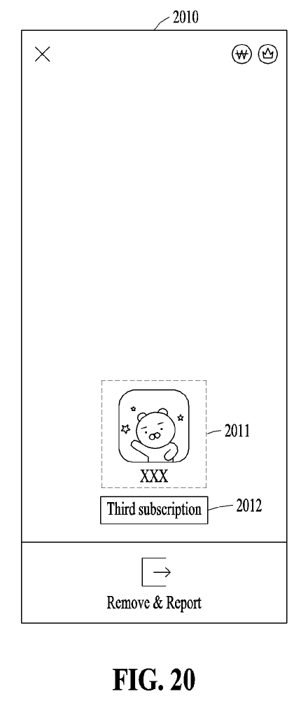

FIG. 20 is a diagram illustrating an example of an operation of a chatroom usage pass subscription system providing a profile according to various embodiments.

A chatroom usage pass subscription system according to an embodiment (e.g., the chatroom usage pass subscription system 100 of FIG. 1) may include an operator terminal (e.g., the operator terminal 110 of FIG. 1 or the operator terminal 310 of FIG. 3), a user terminal (e.g., the user terminal 120 of FIG. 1 or the user terminal 820 of FIG. 8), and a server (e.g., the server 130 of FIG. 1, the server 330 of FIG. 3, or the server 830 of FIG. 8). In the chatroom usage pass subscription system, a profile of the user account participating in a subscription type chatroom may be provided together with information about a period of subscription to a chatroom usage pass.

The operator terminal or the user terminal may request for inquiring about the profile of the subscriber account participating in the subscription type chatroom to the server through a list of participants of the subscription type chatroom participated by the operator terminal or the user terminal.

The server may receive the request for inquiring about the profile of the subscriber account from at least one terminal of the operator terminal or the user terminal.

The server may transmit a display command of a screen further including subscription information for the chatroom usage pass of the subscriber account together with the profile of the subscriber account to the at least one terminal in response to the request for inquiring about the profile.

The subscription information for the chatroom usage pass of the subscriber account may include at least one of information about a period for which the subscriber account has subscribed to the chatroom usage pass, information about the number of payments of the subscription fee, or information about whether the chatroom usage pass has been subscribed with payment.

The operator terminal or the user terminal may display the screen further including the subscription information for the chatroom usage pass of the subscriber account together with the profile of the subscriber account.

Referring to FIG. 20, the operator terminal or the user terminal may display a screen 2010 including information 2012 about the number of times the subscriber account has paid for the subscription fee for the chatroom usage pass together with a profile 2011 of the subscriber account.

According to an embodiment, when the inquiring of the profile of the subscriber account is requested by the operator terminal, the chatroom usage pass subscription system may provide the screen further including the subscription information for the chatroom usage pass of the subscriber account together with the profile of the subscriber account. When the inquiring of a profile of another subscriber account is requested by the subscriber terminal, the chatroom usage pass subscription system may provide the profile (e.g., a profile used to participate in the subscription type chatroom) of the other subscriber account, and restrict the providing of the subscription information for the chatroom usage pass of the other subscriber account to the subscriber terminal.

According to various embodiments of the present disclosure, in FIGS. 1 to 20, the screen displayed by the operator terminal or the user terminal may be displayed in response to the display command of the screen received from the server.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an OS and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method performed by a server, the method comprising:
receiving a chatroom generation request from an0 operator terminal corresponding to an operator account;
generating a chatroom set to be available to a subscriber account that subscribes to a chatroom usage pass in response to the chatroom generation request;
receiving a request to access the chatroom from a user terminal corresponding to a user account; and
granting an access right for the chatroom to the user account based on the chatroom usage pass subscribed by the user account.

2. The method of claim 1, wherein the granting of the access right comprises:
when the user account has not subscribed to the chatroom usage pass, transmitting a subscription request for the chatroom usage pass to the user terminal; and
when payment of a subscription fee of the chatroom generation request is succeeded, providing the chatroom usage pass to the user account.

3. The method of claim 1, wherein the granting of the access right comprises:
setting a period of use indicating a validity period of the right to access granted to the user account based on time at which the payment of the subscription fee is succeeded;
determining a recurring payment date for maintaining subscription to the chatroom usage pass based on a termination date of the set period of use;
when the determined recurring payment date arrives, attempting recurring payment of the subscription fee for the chatroom usage pass; and
when the recurring payment is succeeded, extending the period of use and changing the recurring payment date based on a termination date of the extended period of use.

4. The method of claim 1, wherein the generating of the chatroom comprises:
obtaining a chatroom operation form for an operation of the chatroom from the operator terminal;
when the chatroom operation form is approved, requesting for payment information for revenue based on a subscription fee for the chatroom usage pass to the operator terminal;
when the payment information is obtained from the operator terminal, registering the obtained payment information as payment information of revenue based on the subscription fee for the chatroom usage pass; and
when a configuration of the chatroom is received from the operator terminal after the payment information is obtained, generating the chatroom applied with the received configuration.

5. The method of claim 1, further comprising:
receiving a cancellation request for payment of a subscription fee for the chatroom usage pass form the user terminal; and
determining whether the payment is able to be cancelled based on whether the user account has entered the chatroom.

6. The method of claim 1, further comprising:
receiving an operation termination request for terminating an operation of the chatroom from the operator terminal;
determining an operation termination date of the chatroom in response to the operation termination request;
when the determined operation termination date arrives, removing the subscriber account from the chatroom; and
when the determined operation termination date arrives, allowing the operator account to leave the chatroom.

7. The method of claim 1, further comprising:
receiving a new subscription restriction request for restricting new subscription to the chatroom usage pass from the operator terminal;
setting to restrict the new subscription to the chatroom usage pass in response to the new subscription restriction request;
repeating recurring payment of a subscription fee and extension of a period of use of an existing subscriber account that has subscribed to the chatroom usage pass before the new subscription restriction request to maintain the access right of the existing subscriber account for the chatroom; and
when the user account has not subscribed to the chatroom usage pass, transmitting a display command of a guide message indicating that the new subscription to the chatroom pass is restricted to the user usage terminal.

8. The method of claim 1, further comprising:
restricting the operator account from leaving the chatroom; and
allowing the user account to leave the chatroom.

9. The method of claim 1, further comprising:
receiving an inquiry request for subscription information of the chatroom usage pass from the operator terminal; and
transmitting a display command of a screen comprising the subscription information to the operator terminal in response to the inquiry request,
wherein the subscription information of the chatroom usage pass comprises information about at least one of one or more subscriber accounts that have subscribed to the chatroom usage pass, a payment history of a subscription fee for the chatroom usage pass, a payment history of revenue based on the subscription fee for the chatroom usage pass, or a subscription product corresponding to the chatroom usage pass.

10. The method of claim 1, further comprising:
receiving an inquiry request of information about the chatroom usage pass subscribed by the user account from the user terminal; and
transmitting a display command of a screen comprising at least one of a title of a chatroom corresponding to each chatroom usage pass subscribed by the user account, information about the operator account, information about a payment method, a recurring payment date, a subscription fee, or a period of use to the user terminal in response to the inquiry request.

11. The method of claim 1, further comprising:
receiving a request for extracting and displaying a message sent by the operator account from at least one terminal of the operator terminal or the user terminal;
extracting a message sent by the operator account through the chatroom in response to the received request; and
transmitting a display command of a screen comprising the extracted message to the at least one terminal.

12. The method of claim 1, further comprising:
transmitting a display command of a screen of the chatroom in which a visual effect is applied to a message sent by the operator account to at least one terminal of the operator terminal or the user terminal.

13. The method of claim 1, further comprising:
determining an operating mode of the chatroom as one of a first mode of restricting a user account having a right to send a message through the chatroom as the operator account or a second mode of granting the right to send a message to a user account that has entered the chatroom in response to an operating mode determination request received from the operator terminal;
instructing the user terminal to display a screen on which a function of sending a message through the chatroom is restricted while the operating mode of the chatroom is the first mode; and
instructing the user terminal to display a screen on which the function of sending a message through the chatroom is allowed while the operating mode of the chatroom is the second mode.

14. The method of claim 1, further comprising:
when the user account has not subscribed to the chatroom usage pass, determining whether subscription to the chatroom usage pass is possible based on a comparison result between the number of subscriber accounts of the chatroom usage pass and the number of allowed participants for the chatroom; and
when it is determined that the subscription to the chatroom usage pass is not possible, transmitting a display command of a guide message indicating that the subscription to the chatroom usage pass is restricted due to the number of allowed participants for the chatroom to the user terminal,
wherein, the granting of the access right comprises, when it is determined that new subscription to the chatroom usage pass is possible, transmitting a subscription request for the chatroom usage pass to the user terminal.

15. The method of claim 1, further comprising:
receiving an inquiry request for a profile of the subscriber account from at least one terminal of the operator terminal or the user terminal; and
transmitting a display command of a screen further comprising subscription information of the subscriber account for the chatroom usage pass together with the profile of the subscriber account to the at least one terminal in response to the inquiry request for the profile.

16. The method of claim 1, further comprising:
receiving a right deprivation request for depriving the access right of the user account for the chatroom from the operator terminal;
removing the user account from the chatroom in response to the right deprivation request; and
transmitting a display command of a guide message indicating that the user account is removed from the chatroom to the user terminal.

17. A non-transitory computer-readable storage medium storing instructions that, when executed by one or more processors, cause the one or more processors to perform the method of claim 1.

18. A server comprising:
one or more processors configured to:
receive a chatroom generation request from an operator terminal corresponding to an operator account;
generate a chatroom set to be available to a subscriber account that subscribes to a chatroom usage pass in response to the chatroom generation request;
receive a request to access the chatroom from a user terminal corresponding to a user account; and
grant an access right for the chatroom to the user account based on the chatroom usage pass subscribed by the user account.

19. A method performed by a user terminal, the method comprising:
transmitting a request to access a chatroom set to be available to a subscriber account that subscribes to a chatroom usage pass to a server; and
receiving an access right for the chatroom based on the chatroom usage pass subscribed by a user account corresponding to the user terminal,
wherein the chatroom is generated in response to a chatroom generation request received from an operator terminal corresponding to an operator account.

20. A user terminal comprising:
one or more processors configured to:
transmit a request to access a chatroom set to be available to a subscriber account that subscribes to a chatroom usage pass to a server; and
receive an access right for the chatroom based on the chatroom usage pass subscribed by a user account corresponding to the user terminal,
wherein the chatroom is generated in response to a chatroom generation request received from an operator terminal corresponding to an operator account.
